(19) United States
(12) Patent Application Publication
(10) Pub. No.: US 2016/0088049 A1
(43) Pub. Date: Mar. 24, 2016

(54) INTERNET OF THINGS (IOT) ADAPTATION SERVICES

(71) Applicant: CONVIDA WIRELESS, LLC, Wilmington, DE (US)

(72) Inventors: Dale N. SEED, Allentown, PA (US); Chonggang WANG, Princeton, NJ (US); Lijun DONG, San Diego, CA (US)

(21) Appl. No.: 14/888,970

(22) PCT Filed: May 6, 2014
(86) PCT No.: PCT/US14/36962

§ 371 Date: Nov. 4, 2015

Related U.S. Application Data
(60) Provisional application No. 61/819,871, filed on May 6, 2013.

(51) Int. Cl. H04L 29/06; H04L 29/08

(52) U.S. Cl. CPC H04L 65/602; H04L 67/42; H04L 67/18

(57) ABSTRACT

In one embodiment, a system comprises a plurality of devices which communicate via a network, such as an internet of things (IoT) for example. The devices can be adapted via a network-based adaptation service, wherein the plurality of devices that use the network-based adaptation service can correspond to different clients, such as applications and services for example. The adaptation service can use factors such as, for example, content, context, policies, prior decisions, and events when performing adaptation. Thus, the adaptation service enables intelligent and dynamic forms of adaptation across applications and services.

### CROSS REFERENCE TO RELATED APPLICATIONS

This Application claims the benefit of U.S. Provisional Patent Application Ser. No. 61/819,871 filed May 6, 2013, the disclosure of which is hereby incorporated by reference as if set forth in its entirety herein.

### BACKGROUND

Various forms of adaptation may be used for Internet and Web-based applications and services. Adaptation generally refers to a process in which a system changes (adapts) its behavior based on information. Examples of adaptation include adaptation of an application's or a service's data or content from one format to another, adaptation of the resolution used for a video streaming application based on the type of network connection or available bandwidth, and adaptation of an application's sleep schedule based on a remaining battery level.

From an Internet/Web perspective, current forms of application and service adaptation are generally limited to self-adaptation in which an application or service performs adaptation on itself based on local policies or intelligence. Existing network-based forms of adaptation involve the use of adaptation network proxies, gateways, or services that are specifically built and customized to perform adaptation for a particular type(s) of application/service. An example of application-specific video codec adaptation is performed by YouTube, which will automatically adapt the bitrate of videos being streamed between the YouTube application instance hosted on a device and a YouTube server based on the type of browser being used (e.g., mobile or laptop) and/or the access network connectivity (e.g., WiFi or cellular).

### SUMMARY

Current approaches to adaptation lack a general and intelligent adaptation service that can be used by a diverse set of applications and services. As a result, adaptation is often performed by applications or services themselves, or adaptation is performed by custom proxies, gateways, or services that have been specifically built to perform a particular type of adaptation for a specific type of application or service. Systems, methods, and apparatus embodiments are described herein for adaptation services that can support heterogeneous types of applications and services.

In one embodiment, a system comprises a plurality of devices that communicate via network, such as an Internet of Things (IoT) for example. As used, herein the IoT may refer to a network in which devices can communicate with each other, and thus the IoT may also be referred to as an machine-to-machine (M2M) communication system. Further, while devices, applications, services, and the like are often referred to herein as “IoT” entities, it will be understood that the “IoT” is presented by way of example and not presented by way of limitation. For example, the devices that communicate via the network can be adapted via a network-based IoT adaptation service, wherein the plurality of devices that use the network-based IoT adaptation service can correspond to different IoT applications. The IoT adaptation service can use factors such as, content, context, policies, prior decisions, and events when performing adaptation. Thus, the IoT adaptation service enables intelligent and dynamic forms of adaptation across applications.

In accordance with an example embodiment, a network server that includes an adaptation service may determine that a service that is provided by a network entity should be adapted for a first client and a second client that is different than the first client. The adaptation service, and thus the network server that hosts the adaptation service, may generate first instructions for the network entity to adapt the service that the network entity provides such that the service is compatible with the first client. The adaptation service, and thus the network server that hosts the adaptation service, may further generate second instructions for the network entity to adapt the service that the network entity provides such that the service is compatible with the second client. The first and second instructions may be sent to the network entity, and the first instructions may be different than the second instructions. The adaptation service, and thus the network server that hosts the adaptation service, may determine that the service should be adapted for the first and second clients based on receiving a plurality of adaptation requests. Alternatively, the adaptation service may determine that the first and second clients should be adapted by monitoring information in a network.

### BRIEF DESCRIPTION OF THE DRAWINGS

A more detailed understanding may be had from the following description, given by way of example in conjunction with the accompanying drawings wherein:

FIG. 1A is a block diagram of a system without adaptation services, which illustrates some example problems related to a lack of adaptation;

FIG. 1B is a block diagram that shows an example IoT virtualization service according to an example embodiment;

FIG. 2 is a block diagram of an Internet of Things (IoT) adaptation service in accordance with an example embodiment;

FIG. 3 is a block diagram of example IoT adaptation service capabilities in accordance with an example embodiment;

FIG. 4 illustrates an adaptation capability library in accordance with an example embodiment;

FIG. 5 is a call flow for a direct request for adaptation services according to an example embodiment;

FIG. 6 is a call flow for an indirect request for adaptation services according to an example embodiment;

FIG. 7 is a call flow for collaborative adaptation according to an example embodiment;

FIG. 8A is a system diagram of an example machine-to-machine (M2M) or Internet of Things (IoT) communication system in which one or more disclosed embodiments may be implemented;

FIG. 8B is a system diagram of an example architecture that may be used within the M2M/IoT communications system illustrated in FIG. 8A;

FIG. 8C is a system diagram of an example M2M/IoT terminal or gateway device that may be used within the communications system illustrated in FIG. 8A; and

FIG. 8D is a block diagram of an example computing system in which aspects of the communication system of FIG. 8A may be embodied.

### DETAILED DESCRIPTION OF ILLUSTRATIVE EMBODIMENTS

As referred to herein, an Internet of Things (IoT) refers to a global infrastructure that interconnects things to the Internet. As used herein, the IoT may refer to any network in which devices can communicate with each other, and thus the IoT may also be referred to as a machine-to-machine (M2M) communication system. Further, while devices, applications, services, and the like are often referred to herein as “IoT” devices, applications, services, and the like, it will be understood that the “IoT” qualifier is presented by way of example, and not presented by way of limitation. An IoT system may consist of IoT Things, IoT Entities, IoT Services, and IoT Applications. An IoT Thing refers to a uniquely identifiable physical or virtual thing that is accessible via Internet connectivity (e.g., products, weather, sensors, etc.). An IoT Thing may be connected to the Internet via IoT Devices. An IoT Entity may refer to an IoT network node (e.g., IoT Device, Gateway, Router, Server, or the like). An IoT Application may refer to an application that is hosted on an IoT Entity.

As used herein, an IoT service refers to a service that supports a modular and re-usable set of IoT capabilities that are made accessible via a defined IoT service interface. Capabilities may also be referred to herein as functionalities, without limitation. Thus, adaptation capabilities may also be referred to herein as adaptation functionalities, without limitation. An IoT service interface may define the means by which the IoT service can be interacted with. For example, the IoT service interface may define the IoT protocols and IoT primitives supported by the IoT service. An example IoT service interface operation defines one supported action of the IoT service interface. An IoT information model may refer to a representation of concepts with relationships, constraints, rules, and operations to specify data for the IoT domain. An IoT information element may refer to one particular instance of IoT information (e.g., content, context, policy, event, decision, or the like). For example, an IoT information element may be associated with a corresponding IoT information category that defines the IoT information element's type and structure.

As described in detail below, in accordance with various embodiments, an IoT adaptation service supports an intelligent and general set of IoT adaptation capabilities that can be used by a broad and heterogeneous set of network applications and services. As used herein, an IoT adaptation capability may refer to a particular type or form of adaptation supported by an IoT adaptation service. Adaptation generally refers to a process in which a system changes (adapts) its behavior based on information. Example IoT adaptation capabilities described herein may differ from traditional forms of adaptation in that they are meant to be broader in nature such that they are not customized to a particular application or service. Thus, various example capabilities that are described herein can be offered by an IoT adaptation service as general adaptation capabilities that can be used by a broad heterogeneous set of applications and services in the network.

It has been recognized herein that a future IoT may include IoT-type devices that have migrated towards a service oriented architecture and IoT-type devices that offer their capabilities via services. Further, IoT networks may migrate toward a service oriented architecture that hosts network-based services upon network nodes such as cloud servers, gateways, and routers for example, to assist and enable IoT devices and applications to interact with one another in an intelligent and efficient manner. Thus, IoT devices and applications that interact with each other in such a manner can also be referred to as a Web of Things (WoT) or an Internet of Services (IoS).

It is further recognized herein that, coupled with a migration to a more services based architecture, future IoT networks may also become more information centric and aware as compared to previous IoT networks. For example, future IoT messages may contain higher-level forms of information as compared to previous IoT messages. Such forms of information can be made accessible and interpretable, not just to endpoint applications, but also to network-based services (e.g., web services) hosted on intermediate nodes in the network. Such higher-level information may include, for example, metadata that describes the data and can be used to interpret the data (e.g., semantics), context information such as where data originated from for example, or policy information that defines rules related to information in the message. Higher-level forms of information may enable more intelligent applications and services deployed on IoT devices and IoT network nodes (e.g., routers, servers, etc.). Higher-level forms of information may also enable the realization of more intelligent and general forms of adaptation services supported within the Internet.

As described herein, IoT services and applications may benefit from more intelligent and more general adaptation service mechanisms as compared to existing adaptation service mechanisms. For example, using adaptation service mechanisms described herein, IoT services can support adaptation of their services for resource constrained IoT devices, which themselves may have limited or no capability to adapt. Similarly, adapting an example IoT service to the needs and requirements of various IoT applications can increase, for example, the number and types of IoT applications that can make use of the example IoT service. In various example embodiments described herein, an awareness of higher-level forms of information is leveraged and coupled with adaptation services to create intelligent services (e.g., IoT services).

As discussed above, the Internet/Web lacks general and intelligent network-based adaptation services that can be used by a diverse set of applications and services. As a result, adaptation is often performed by the applications or services themselves or by custom proxies, gateways, or services that have been specifically built to perform a particular type of adaptation for a specific type of application or service. To enable an agile IoT described herein, various embodiments described below provide intelligent and general network-based adaptation services.

Without general network-based adaptation services available in a network, adaptation may instead be performed by the applications and services themselves or by introducing an increasing amount of customized adaptation proxies/gateways/services into the Internet. Such customizations may introduce additional complexity, management, and cost to the Internet. Conversely, an IoT described herein defines new forms of information that IoT applications and services can generate, consume, and share with one another. Standardization of this information may ensure universal adoption across IoT applications and services. Some examples of such information include metadata (e.g., semantics), context, policies, or the like. Such forms of information may enable intelligent and complex forms of adaptation such as, for example, new types of context aware and policy based adaptation of IoT applications and services.

IoT applications and services may be hosted upon network nodes (e.g., IoT end devices) that have scarce resources or limited human interaction. Further, the capability of the applications and services to perform their own adaptation may be limited by the type of network node that they are hosted upon. Various embodiments described herein include general network-based adaptation services that allow applications and services to offload their adaptations to these services. Described embodiments further include network-based adaptation services that may autonomously change the behavior of a service or an application based on information such as, for example, an observed context, events, policies, a decision making capability, or the like.

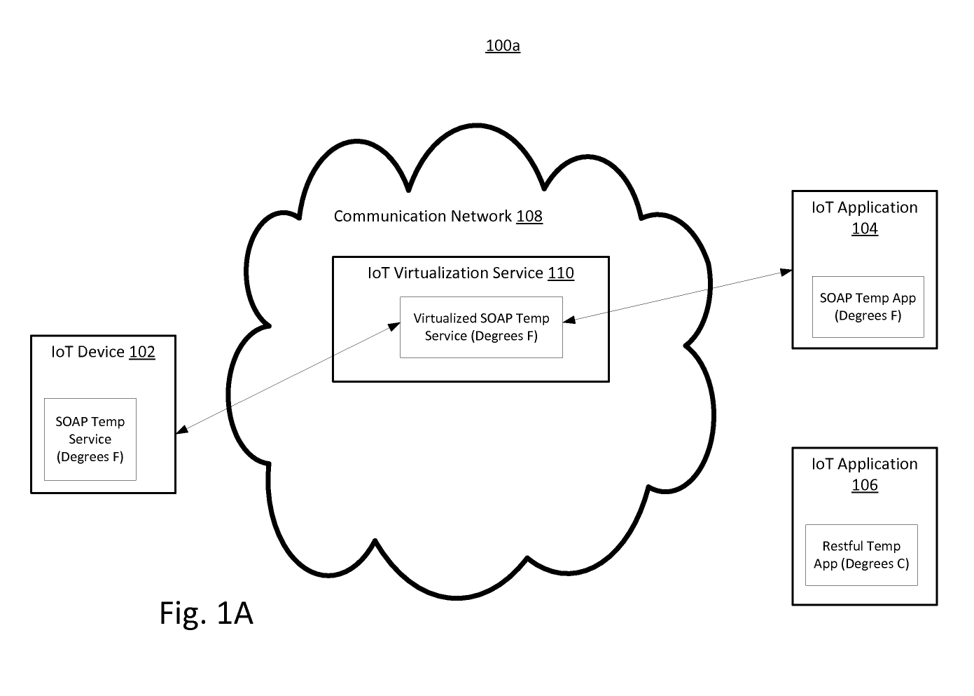

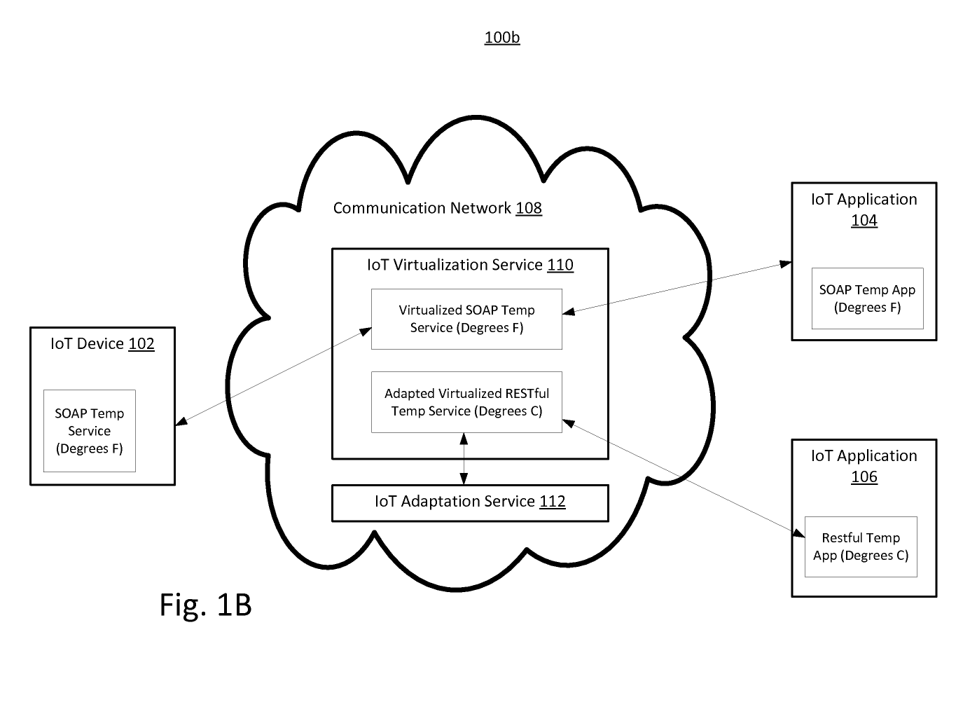

FIG. 1 illustrates an example system 100a that lacks network-based adaptation services. As used herein, an adaptation service may be referred to as network-based if it can be accessed via a communication network, for example, by an application or another service. Referring to FIG. 1, the system 100a includes an example IoT device 102, a first IoT application 104, and a second IoT application 106. The IoT device 102 may communicate to applications, for instance the first IoT application 104, via a network 108. The IoT device 102 may be a resource constrained IoT device. In accordance with the illustrated example, the IoT device 102 is an IoT temperature sensor, and thus the IoT device 102 may also be referred to as an IoT temperature sensor 102. The IoT temperature sensor 102 may be owned by a weather service company or a weather agency, such as a government owned national weather service for example. In accordance with the illustrated example, the temperature sensor 102 is virtualized by a network-based IoT virtualization service 110 that resides on the network 108. The network 108 may be owned by a machine-to-machine (M2M) service provider, such as Verizon, AT&T, or the like. Thus, the IoT virtualization service 110 may be owned by the M2M service provider.

By virtualizing the IoT device 102, a load on the IoT device 102 may be reduced. An example load on the IoT device 102 may result from requests originating from one or more applications, such as the first and second IoT applications 104 and 106 for example. The virtualization service 110 can absorb loads on behalf of the IoT device 102. For example, the illustrated virtualized IoT temperature sensor 102 is compatible with the first IoT application 104, and the IoT sensor 102 can communicate with the first IoT application 104 via the network 108, and in particular the virtualization service 110. In accordance with the illustrated example, the first IoT application 104 may be owned by a first weather service company. For example, the first IoT application 104 may require temperature readings in degrees Fahrenheit, and the IoT device 102 may provide temperature readings in degrees Fahrenheit. By way of further example, the IoT device 102 and the first IoT application may use first protocol, such as a simple object access protocol (SOAP) for example, to communicate with the IoT virtualization service 110, and thus with each other. SOAP generally refers to protocol that relies on an XML information set for its message format. Alternatively, in accordance with the illustrated example, the second IoT application 106 may use a second protocol, such as a representational state transfer (REST) interface (RESTful) for example, to communicate such that the second IoT application 106 is not compatible with the IoT device 102 in the system 100a. RESTful generally refers to an architecture that includes clients that issue semantic requests to servers, and servers return appropriate semantic responses. For example, the second IoT application 106 may be owned by a different weather service company than the first weather service company, and the second IoT application 106 may require temperature readings in degrees Celsius. In the example illustrated in FIG. 1, neither the IoT device 102 itself nor the virtualization service 110 support adapting the interface and content to match the interface (RESTful) and content (Celsius) requirements of the second IoT application 106. Further, in accordance with the illustrated example, the second IoT application 106 does not support adaptation. Thus, the second IoT application 106 is unable to use the IoT virtualization service 110. Further, the second IoT application 106 is unable to obtain temperature readings from the IoT temperature sensor 102. In accordance with an example embodiment, referring to FIG. 1B, an example IoT adaptation service 112 addresses the example problems identified in the description of FIG. 1A.

FIG. 1B illustrates an example system 100b that includes the IoT device 102, the first IoT application 104, the second IoT application 106, the IoT virtualization service 110, and the IoT adaptation service 112, which may communicate with each other via the network 108. The IoT device 102 may communicate with one or more applications, for instance the first IoT application 104 and the second IoT application, via the network 108. It will be appreciated that the example system 100b is simplified to facilitate description of the disclosed subject matter and is not intended to limit the scope of this disclosure. Other devices, systems, and configurations may be used to implement the embodiments disclosed herein in addition to, or instead of, a system such as the system 100b, and all such embodiments are contemplated as within the scope of the present disclosure.

Still referring to FIG. 1B, the illustrated IoT adaptation service 112 can be leveraged by the IoT virtualization service 110 to adapt the virtualized IoT device 102 into another instance, for instance a new instance, of the virtualized IoT device 102 that meets the requirements of the second IoT application 106. In accordance with the illustrated embodiment, the new instance of the virtualized IoT device 102 is compatible with the interface (RESTful) of the second application 106. The new instance of the virtualized IoT device 102 is further compatible with functional requirements (e.g., temperature in degrees Celsius) of the second application 106. Thus, the illustrated IoT adaptation service 112 enables the IoT virtualization service 110 to become adaptive in nature. The IoT adaptation service 112 can be owned and operated by the same service provider that owns the IoT virtualization service 110 or it can be owned by a different service provider than the service provider that owns the IoT virtualization service 110.

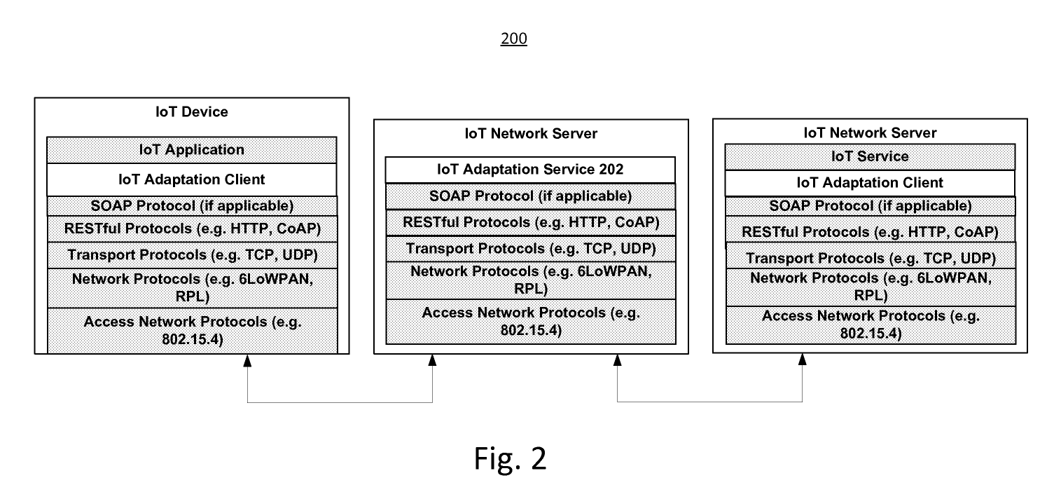

FIG. 2 is a block diagram that shows an example IoT adaptation service 202 in an example system 200. Referring to FIG. 2, the IoT adaptation service 202 can be used to address problems described above (e.g., see FIG. 1A). The IoT adaptation service 202 can be implemented as a general service in the network.

As described further below IoT adaptation services in accordance with various embodiments can enable intelligent and dynamic adaptation of applications and services hosted on various entities in the network (e.g., devices, routers, gateways, servers). Thus, adaptation services descried herein can be considered smart (e.g., intelligent), for example, because they can perform adaptation in an information-aware manner and they can factor in content-awareness, context awareness, policies, prior decisions, and events when performing the adaptation. Thus, the IoT adaptation services described herein can enable intelligent and dynamic forms of adaptation.

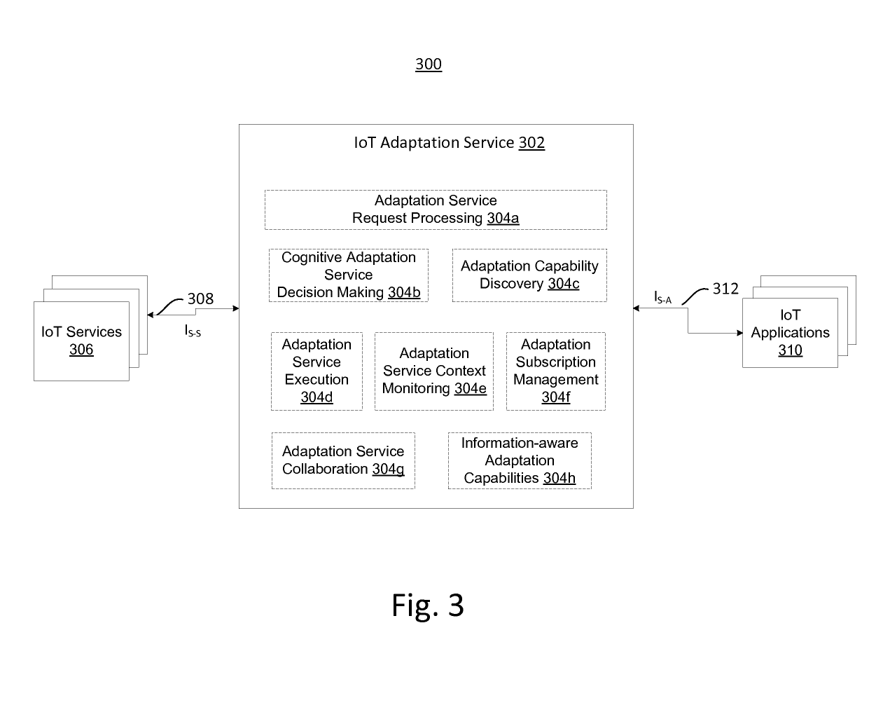

Referring to FIG. 3, an IoT adaptation service, such as an IoT application service 302, may provide one or more capabilities 304. The illustrated embodiment shown in FIG. 3 shows an architecture 300 for the adaptation service 302, which may be referred to as a general information-aware network-based IoT adaptation service 302. While the illustrated IoT adaptation service 302 can perform the illustrated functions 304, it will be understood that an IoT adaptation service can perform other functions as desired in accordance with an example embodiment. The IoT adaptation service 302 may communicate with one or more IoT services 306 via an interface 308, which may be referred to as an interface between services (I_{S-S}). The IoT adaptation service 302 may communicate with one or more IoT applications 310 via an interface 312, which may be referred to as an interface between a service and applications (I_{S-A}). The IoT applications 310 may be hosted on various entities in a network, such as, for example, a device, a server, a gateway, a router, or the like. Further, the IoT services 306 may be hosted on various entities in a network, such as, for example, a device, a server, a gateway, a router, or the like. Thus, the IoT adaptation service 302 supports receiving requests to perform adaptation of the IoT applications 310 and the IoT services 306 that may be hosted on various entities in the network.

Requests to the IoT adaptation service 302 can originate from the applications 310 or the services 306. For example, one of the services 306 may be a publishing service, and the publishing service can request that the adaptation service 302 adapt information that the publishing service publishes. By way of further example, the publishing service may request that the adaptation service 302 adapts a publishing schedule based on information that the adaptation service 302 is able to collect and interpret about the network. For example, the adaptation service 302 may collect the types of applications 310 in the network, respective locations of the applications 310, or a level of interest that each application 310 has in published information.

In accordance with an example embodiment, an IoT network server that includes the adaptation service 302 may determine that one of the applications 310 or services 306, which may be referred to as a first client, should be adapted. The IoT network server may further determine that another one of the applications 310 or services 306, which may be referred to as a second client, should be adapted. The second client may be different than the first client. The adaptation service 302, and thus the IoT network server that hosts the adaptation service 302, may generate first instructions for an IoT entity to adapt a service that the IoT entity provides such that the service is compatible with the first client. The adaptation service 302, and thus the IoT network server that hosts the adaptation service 302, may further generate second instructions for the IoT entity to adapt the service that the IoT entity provides such that the service is compatible with the second client. The first and second instructions may be sent to the IoT entity, and the first instructions may be different than the second instructions. In some cases, the adaptation service 302 may instruct different clients to adapt by sending notifications to clients that subscribe to the adaptation service 302. The notifications may be sent to clients when adaptation is required. For example, as further described below, these notifications can be based on adaptation policies, context information, or the like, which each client may specify in its respective subscription to the adaptation service 302. In some cases, the adaptation service 302 can include instructions on how the client is to adapt itself within the notification. Alternatively, the notification can include a call-back function, which the client can call for the function to perform a specific type of adaptation on the client. The IoT service 302 may determine that the first and second client should be adapted based on receiving a plurality of adaptation requests. Alternatively, the IoT adaptation service 302 may determine that the first and second clients should be adapted by monitoring context information.

By way of another example, the network server that includes the adaptation service 302 may determine that a service 306x that is provided by a network entity should be adapted for a first client (e.g., one of the services 306 or applications 310) and a second client (e.g., another one of the services 306 or applications 310) that is different than the first client. The adaptation service 302, and thus the network server that hosts the adaptation service, may generate first instructions for the network entity to adapt the service 306x that the network entity provides such that the service 306x is compatible with the first client. The adaptation service 302, and thus the network server that hosts the adaptation service, may further generate second instructions for the network entity to adapt the service 306x that the network entity provides such that the service 306x is compatible with the second client. The first and second instructions may be sent to the network entity, and the first instructions may be different than the second instructions. The adaptation service 302, and thus the network server that hosts the adaptation service 302, may determine that the service should be adapted for the first and second clients based on receiving a plurality of adaptation requests. In one embodiment, the adaptation service 302 receives requests to adapt each client. In each of these requests, input may be provided to the adaptation service 302 and the adaptation service 302 uses the input to individually adapt each client. In another embodiment, the network server that hosts the adaptation service 302 receives a request associated with the first client and a request associated with the second client. Thus, the adaptation service 302 may determine that a service provided by a network entity should be adapted for the first client and the second client based on receiving a plurality of adaptation requests. In yet another embodiment, the adaptation service 302 can support policies that it can use to autonomously adapt each of the first and second clients. Alternatively, the adaptation service 302 may determine that the first and second clients should be adapted by monitoring information in a network. For example, the adaptation service 302 may monitor context information that is specific to each client, and in turn generate client specific adaptation instructions. By way of further example, the network server that hosts the adaptation service 302 may monitor the service 302x, and based on the monitoring, may determine that the service 302x should be adapted for one or more clients, such as the first client and the second client for example.

As described further below, the architecture 300, and in particular the IoT adaptation service 302, may support intelligent decision making capabilities such that the adaptation service 302 can make cognitive decisions regarding how to process incoming adaptation requests. The IoT adaptation service 302 may also support autonomous adaptation related decision making on its own without requiring explicit requests from a client, such as one of the services 306 or one of the applications 310 for example. The term client, as used herein, may refer to any application or service. Thus, the IoT adaptation service 302 can make autonomous decisions to adapt IoT services 306 and applications 310 as well as the network entities they are hosted upon. To make these decisions, the IoT adaptation service 302 may factor context information and policies that, for example, can be provided as inputs to the adaptation service 302. For example, context information and policies may be supplied to the IoT adaptation service 302 from various network-based services and/or applications that interface with the network. Alternatively, the IoT adaptation service 302 may autonomously collect and generate information. For example, the IoT adaptation service 302 may collect information by monitoring past requests that it receives and past responses that it generates.

The illustrated IoT adaptation service 302 may also support intelligent collaboration with other services and capabilities within the network, as further described below. Via collaboration, for example, the adaptation service 302 can leverage the features of other services and capabilities in the network to enhance its own intelligence and capabilities, as well as to increase the scope and type of adaptation services it makes available. For example, the adaptation service 302 can use collaboration to collect context information from other nodes in the network, receive alerts from other nodes in the network regarding events, collaborate with other adaptation services that may be distributed throughout the network, or the like.

The illustrated capabilities 304 are described further below. Referring to FIG. 3, in accordance with the illustrated embodiment, the IoT adaptation service 302 includes an adaptation service request process capability 304a, a cognitive adaptation service decision making capability 304b, an adaptation capability discovery capability 304c, an adaptation service execution capability 304d, an adaptation service context monitoring capability 304e, an adaptation subscription management capability 304f, an adaptation service collaboration capability 304g, and information-aware adaptation capabilities 304h. It will be understood that the IoT adaptation service 302 may include other capabilities in addition to, or alternatively to, the illustrated capabilities as desired. Further, the capabilities 304 may also be referred to as components 304 of the adaptation service 302, without limitation.

In accordance with the illustrated embodiment, the example IoT adaptation service 302 includes the adaptation service request processing component 304a. The adaptation service request processing component 304a may receive general service-based adaptation requests from the client applications 310 and services 306. Further, the component 304a, and thus the adaptation service 302, may conduct admission control for incoming adaptation requests; buffers and prioritize accepted incoming adaptation requests; adjust the priority of adaptation requests; consolidate and/or aggregate similar or duplicate adaptation requests; and/or schedule adaptation requests based on their priority, service level agreements, policies, or the like. As described herein, various different types of adaptation requests can be received and supported by the component 304a. Further, various different request formats may be received by the adaptation service 302.

The illustrated adaptation capability discovery capability 304c supports servicing adaptation capability discovery and publishing requests from the client applications 310 and the services 306. Using this capability, for example, other clients in the network can discover the adaptation capabilities of the adaptation service 302. Via collaboration, the adaptation service 302 can also enable clients, for instance the services 306 and the applications 310, to discover adaptation capabilities that are hosted on other adaptation service instances as well those capabilities that the adaptation service 302 natively supports.

The illustrated cognitive adaptation service decision making component 304b, and thus the adaptation service 302, may support cognitive decision making capabilities. The cognitive adaptation service decision making component 304b may make decisions related to adaptation. For example, the cognitive adaptation service decision making component 304b may determine: which of the applications 310 or the services 306 to adapt; under what conditions to perform adaptation; what type of adaptation to perform; whether to collaborate with other services 306 in the network to perform adaptation; or the like. Decision making can be performed natively or via collaboration with other cognitive decision making services in the network. Cognitive decision making capabilities can be used by the adaptation service 302. For example, the component 304b may enable the adaptation service 302 to support servicing requests to dynamically adapt policies that can be disseminated to other services 306 and applications 310 in the network. Examples include policies that control which of the network services 306 collaborate with one another, and policies that control the behavior of the network services 306 or applications 310 based on certain context or content (e.g., dynamically control policies for service classification, service publishing, discovery and negotiation, service delivery, service composition and adaptation, service mobility management, service virtualization, service charging, or the like). Other example policies control if/when a given network service or application uses cloud-based services.

With continuing reference to FIG. 3, in accordance with the illustrated embodiment, the adaptation service execution component 304d performs adaptation on a targeted network service or application, for instance one of the services 306 or the applications 310. The adaptation can be performed by using native adaptation capabilities that are supported by the adaptation service 302 or by using adaptation capabilities supported by other adaptation service instances, for instance one of the services 306, in the network through collaboration.

The illustrated adaptation service context monitoring component 304 may monitor context related to adaptation service decision making, collaboration, and execution. As used herein, context may generally refer to information that can be used to describe, track, and/or infer the situational state or condition of a service, an application, a device, a network, or a combination thereof. In an example embodiment, context is used to dynamically adjust future decisions and actions of the adaptation service 302. Monitoring of context can be supported by the adaptation service 302 interacting with underlying protocol layers or services upon which the adaptation service 302 is hosted. Further, context may be monitored by other entities or services in the network that the adaptation service 302 can collaborate with (e.g., a context broker service). Context information that results from monitoring can also be supplied to the adaptation service 302 by another service or application in the network, such as ones of the services 306 and the applications 310 for example. Collaboration can also be used to gather monitoring information.

The illustrated adaptation service subscription management component 304f may enable the adaptation service 306 to support adaptation subscriptions from its clients. Clients of the adaptation service 302 may refer to one or more of the services 306 or the applications 310. Adaptation subscriptions may allow clients to subscribe to the adaptation service 302. Clients may subscribe to various adaptation services based on, for example specific adaptation conditions, a type of desired adaptation, an adaptation target that clients would like an adaptation performed upon, or the like. For example, the adaptation service 302 may detect the occurrence of conditions that are specified by a client, and the adaptation service 302 may then perform a specified adaptation on intended targets. Targets may include ones of the services 306 or the applications 310, for example. By way of example, one or more clients, such as a first and a second client for example, may subscribe to the adaptation service 302 that may be hosted on a network server such that the first client has a first subscription with the adaptation service 302 and the second client has a second subscription with the adaptation service 302. The first and second subscriptions may specify parameters that indicate when and how the first and second clients, respectively, should be adapted. Thus, based on the first subscription, the adaptation service 302 may generate first instructions for a network entity to adapt a service for the first client, and based on the second subscription, the adaptation service 302 may generate second instructions for the network entity to adapt the service for the second client. The first instructions may be different than the second instructions.

Still referring to FIG. 3, the adaptation service collaboration component 304g may apply to scenarios in which requested adaptation service(s) are hosted on multiple network entities. For example, the collaboration component 304g can be used between the services that are hosted on multiple network entities such that decisions on if/when to perform adaptation can be made in a collaborative manner. The collaboration component 304g can be used to separate an adaptation such that portions of the adaptation are performed by different adaptation service instances. Multiple instances of an adaptation service may be disbursed throughout a network and multiple instances of an adaptation service may be hosted on various network entities within a network. The collaboration component 304g can be used by one or more adaptation service instances, for example the adaptation service 302, to coordinate the adaptation of services or applications, such as ones of the services 306 and the applications 310 for example. The adaptation service 302 can also collaborate with cloud based services and resources to perform resource intensive adaptation operations. For example, the adaptation service 302 may use cloud-based services to offload certain adaptation operations to the cloud. The collaboration component 304g can also be used by the adaptation service 302 to enhance adaptation publishing and discovery capabilities. The collaboration component 304g may also enable the adaptation service 302 to collaborate with other types of services and capabilities in the network.

The illustrated information-aware adaptation capabilities can support one or more adaptation capabilities that can be used by clients, such as the services 306 or the applications 310 for example. The one or more adaptation capabilities can support awareness of higher-level forms of information such as semantics, policies, events, or the like. Via this awareness, for example, the adaptation capabilities can support intelligent forms of adaptation in a general, non-customized manner. The IoT adaptation service 302 can provide one or more adaptation capabilities, which can be referred to as native adaptation capabilities. In an example embodiment, the IoT adaptation service 302 provides adaptation capabilities that are not native adaptation capabilities. For example, as described herein, the IoT adaptation service 302 can collaborate with other IoT adaptation service instances in a network to make use of corresponding adaptation capabilities of the other IoT adaptation service instances.

Still referring to FIG. 3, the illustrated IoT adaptation service 302 supports the interface to applications (I_{S-A}) 312 and the interface to other services in the network (I_{S-S}) 308. In accordance with the illustrated embodiment, the interfaces 308 and 312 enable the IoT adaptation service 302 to communicate with IoT services 306 and IoT applications 310, respectively. It will be understood that the services 306 and the applications 310 may be hosted on various network entities, such as IoT devices for example, within a network. Thus, the interfaces 308 and 312 may enable the IoT service 302 to communicate with various network entities.

In accordance with the illustrated embodiment, the I_{S-A} interface 312 enables the adaptation service 302 to receive adaptation requests, for example, from the applications 310. The adaptation requests may include requests to perform adaptation on behalf of respective applications 310. For example, one of the applications 310 may request that the adaptation service 310 adapts a designated IoT information element (e.g., a content instance). Further, the adaptation requests can target adaptation of different IoT applications, IoT services, or IoT network entities that the IoT application, IoT service, or IoT network entity that sends the request to the adaptation service 302.

In accordance with the illustrated embodiment, the I_{S-A} interface 312 also enables the adaptation service 302 to issue adaptation requests to the applications 310. The issued adaptation requests over the interface 312 can originate from the IoT adaptation service 302, and such requests can be referred to as autonomous requests. Alternatively, the issued adaptation requests can originate from other applications or services in the network, such as ones of the services 306 or the applications 310, and such requests can be forwarded to another one of the applications 310, which can be referred to as a target application, over the interface 312 by the adaptation service 302. By way of example, and without limitation, the adaptation service 302 may issue requests over the interface 312 to adapt an application's functionality, interfaces, content that it generates, or the like, in order to throttle the application's rate of requests to the network during periods when the network is highly congested.

In accordance with the illustrated embodiment, the adaptation service 302 may receive adaptation requests from the services 306 over the I_{S-S} interface 308. The adaptation service 302 may perform adaptation on behalf of the services 306. The adaptation requests that the adaptation service 302 receives from the services 306 may target adaptation of other ones of IoT services 306 or IoT applications, such as ones of the applications 310.

With continuing reference to FIG. 3, the I_{S-S} interface 308 may enable the IoT adaptation service 302 to issue adaptation requests that target the IoT services 306 in the network. The issued adaptation requests over the interface 308 can originate from the IoT adaptation service 302, and such requests can be referred to as autonomous requests. Alternatively, the issued adaptation requests over the interface 308 can originate from other applications or services in the network, such as ones of the services 306 or the applications 310, and such requests can be forwarded to another one of the services 306, which can be referred to as a target service, by the adaptation service 302. By way of example, requests that are issued over the interface 308 can be used to adapt a service's functionality, interfaces, content that it generates, or the like. For example, an interface of one of the services 306 can be adapted to meet the requirements of a particular application, such as one of the applications 310 for example, that has an interface that is not compatible with the interface of the service 306. The requests that are issued over the interface 308 can also be used for collaboration purposes between multiple network instances of the IoT adaptation service 302.

While adaptation requests, as described above, may be sent and received over the I_{S-A} 312 and the I_{S-S} interface 308, it will be understood that adaptation service requests may be sent and received over other interfaces as desired.

The various types of adaptation service requests that are described herein, such as those that are sent and received over the interfaces 308 and 312 for example, can be implemented as a new adaptation service protocol. Alternatively, adaptation service requests can be bound to one or more existing protocols. By way of example, adaptation service requests and corresponding responses can be bound to protocols such as hypertext transfer protocol (HTTP), constrained application protocol (CoAP), or the like. For example, protocols such as HTTP or CoAP can be used as an underlying transport protocol for carrying the different types of adaptation service requests and responses. The adaptation requests and responses can be encapsulated within the payload of messages, such as HTTP or CoAP messages for example. Alternatively, information within the adaptation service requests and responses can be bound to fields within headers and/or options, for example HTTP/CoAP headers and/or options. In one example embodiment, adaptation service requests and response protocol primitives can be encoded as JavaScript Object Notation (JSON) or extensible markup language (XML) descriptions that are carried in the payload of HTTP or CoAP requests and responses. As a result, adaptation applications and services can encode/decode adaptation service protocol JSON/XML primitives and use HTTP or CoAP as an underlying transport for exchanging these adaptation service primitives with one another.

Referring generally to FIG. 3, various types of adaptation requests can be received by the adaptation service 302. Various example adaptation requests are described below. For example, one of the IoT applications 310 or services 306 may request that the IoT adaptation service 302 perform adaptation based on one or more of the types of adaptation natively supported by the service 302. The applications 310 or services 306 may discover other features that the adaptation service 302 supports. For example, a request may include a request to discover whether the adaptation service 302 supports collaborating with other adaptation services, or whether the adaptation service 302 supports receiving an adaptation capability that the adaptation service 302 can then use when servicing a particular adaptation request.

Another example adaptation request is a request by one of the IoT applications 310 or services 306 for the IoT adaptation service 302 to perform adaptation on behalf of one of the IoT applications 310 or services 306. Such a request may be preceded by a determination that adaptation service 302 can support or perform the requested adaptation. For example, the adaptation service 302 may receive a request to perform adaptation on an IoT information element that is passed within the request, and to return the adapted information element within a response.

Yet another example adaptation request is a request by one of the IoT applications 310 or services 306 for the IoT adaptation service 302 to perform adaptation on one or more other IoT applications, services, or entities in the network. For example, one of the applications 310 can request that the IoT adaptation service 302 perform adaptation on one of the network services 306 that the one application 310 would like to use but is not compatible with. In response to the request, the adaptation service 302 may adapt an interface of the one service 306 such that the service 306 is compatible with an interface of the one application 310.

Yet another example type of adaptation request is a request by one of the IoT applications 310 or services 306 to subscribe to the IoT adaptation service 302. The applications 310 and the services 306 may subscribe to the adaptation service 302 so that they receive future adaptation notifications or requests from the IoT adaptation service 302 if/when particular adaptation conditions are met that require particular subscribing IoT applications 310 and services 306 to adapt.

An example adaptation request, which may be referred to as an autonomous request, is generated by the adaptation service 302. The autonomous request may be sent to the services 306 or the applications 310, and the request may include a request for the services 306 or the applications 310 to adapt. For example, the IoT adaptation service 302 can observe context information, such as a network congestion status or whether IoT devices are overloaded. Based on the observed context information, the adaptation service 302 and can intelligently decide, using policies for example, to perform adaptation on one or more of the IoT applications 310, services 306, or entities. The performed adaptation may be referred to as a corrective action, for example, that is performed in response to the observed context information (e.g., network congestion, overloaded IoT devices).

The IoT applications 310 and services 306 can send another example adaptation request, to the adaptation service 302, to create a new adaptation capability within the IoT adaptation service 302. A new adaptation capability may refer to a capability that is not natively supported by the adaptation service 302. Thus, one of the IoT applications 310 or services 306 can use an adaptation request to add a new adaptation capability to the IoT adaptation service 302. For example, a new adaptation capability can be created for translating the output of one of the services 306 such that the output meets interface requirements of one or more of the applications 310.

Yet another example type of request is a request by one instance of an IoT adaptation service to collaborate with another instance of an IoT adaptation service. This type of request may be collectively referred to as a collaboration adaptation request. For example, the IoT adaptation service 302 can use a collaboration adaptation request to discover the adaptation capabilities supported by other instances of IoT adaptation services. Further, the adaptation service 302 may issue a collaboration adaptation request to publish its supported adaptation capabilities to other instances of adaptation services. The IoT adaptation service 302 can also use a collaboration adaptation request to forward an adaptation request to other instances of IoT adaptation services such as, for example, in situations where a certain adaptation capability is not natively supported by the adaptation service 302 or if one instance of the adaptations service 302 is overloaded.

Described above are various examples of adaptation requests that can be sent and received by the adaptation service 302 over the interfaces 308 and 312, though it will be understood that adaptation requests that are within the scope of this disclosure are not limited to the examples described above. Example adaptation requests are further described below.

Still referring generally to FIG. 3, example adaptation requests can also be generally referred to as request operations. One example request operation includes a discovery query. The discovery query may be sent to the adaptation service 302 in order to determine the types of adaptation capabilities supported by the adaptation service 302. The discovery query may also be sent to the adaptation service 302 to determine whether the adaptation service 302 supports a particular type of adaptation capability that one of the services 306 or applications 310, which can be referred to generally as a client, is seeking.

An example request operation can further include a list of one or more identifiers and/or addresses of one or more intended targets in which the IoT adaptation service 302 is to perform adaptation upon. For example, the adaptation request can contain a list of targeted applications, services, information elements, or the like, to adapt.

An example request operation can further include a list of one or more policies, and in particular references or links to the one or more policies, that the IoT adaptation service 302 may use to qualify whether adaptation should be performed on one or more intended targets. For example, a request can contain a list of policies that defines adaptation conditions for which the IoT adaptation service 302 is to verify are valid before performing adaptation on the intended targets.

In accordance with an example embodiment, an example request operation includes a list of one or more instances of context information that the IoT adaptation service 302 can use as input into adaptation operations. The one more instances of context information may be used for decision making. In some cases, policies are dependent on context information. For example, a request can contain context information related to the occurrence of a particular event that happened. An example of a particular event includes a new service instance of a particular type joining the network. The IoT adaptation service 302 can factor the context information into its decision making on whether to perform adaptation or not. This can be done, for example, using existing policies that have dependencies on the context information, or the adaptation service 302 can support intelligence to generate new policies based off of the context information. These new policies can be used to qualify future adaptation decisions according to an example embodiment.

In accordance with another example embodiment, a request operation can include a list of one or more types of adaptations to perform on one or more intended targets. This list can specify adaptation capabilities that are natively supported by the IoT adaptation service 302. The list can also specify links to adaptation capabilities hosted elsewhere in the network (e.g., by other instances of IoT adaptation services). The list of adaptation capabilities can also include one or more embedded adaptation capabilities (e.g., a binary executable) that a requester (e.g., one of the services 306 or applications 310) would like the IoT adaptation service 302 to use when performing the adaptation.

An example request operation can further include subscription information. Thus subscription information may allow a requester to subscribe to the IoT adaptation service 302. The requester, which may be one of the services 306 or applications 310, may subscribe to the adaptation service 302 for the purposes of having adaptation notifications sent to the requester, which can thus also be referred to as a target, when a specified adaptation condition is met. Subscription information can include conditions (e.g., policies) for which the IoT adaptation service 302 is to trigger an adaptation notification. In another example embodiment, an example request operation includes a list of one or more new adaptation capabilities that are to be created and/or added to an IoT adaptation service instance.

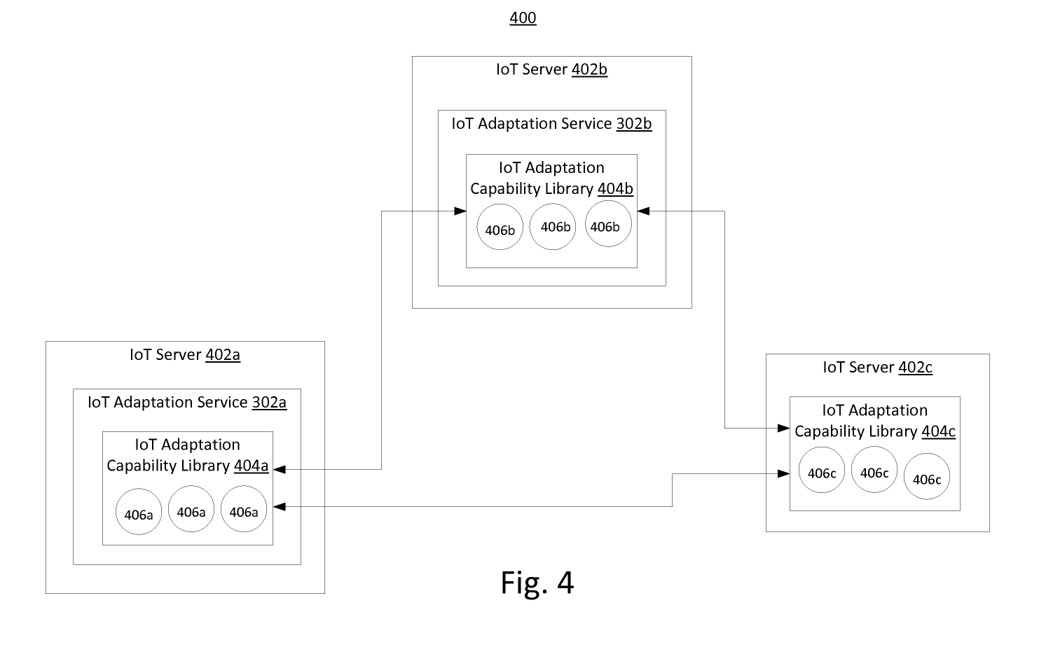

Referring now to FIG. 4, an example system 400 may implement various embodiments described herein. The system 400 may include a plurality of devices 402, such as a first IoT network server 402a, a second IoT network server 402b, and a third IoT network server 402c, that communicate with each other in a network. It will be understood that the example system 400 is simplified to facilitate description of the disclosed subject matter and is not intended to limit the scope of this disclosure. Other devices, systems, and configurations may be used to implement the embodiments described herein in addition to, or instead of, a system such as the system 400, and such embodiments are contemplated as within the scope of the present disclosure.

With continuing reference to FIG. 4, one or more adaptation services, for instance one or more of the adaptation services 302, may reside on each of the devices 402. Thus, the devices 402 may include one or more of the adaptation services 302. For example, in accordance with the illustrated embodiment, a first IoT adaptation service 302a resides on the first server 402a, and a second IoT adaptation service 302b resides on the second server 402b. The devices 402 may further include one or more IoT adaptation capability libraries 404. In accordance with the illustrated embodiment, the first IoT server 402a includes a first IoT adaptation capability library 404a, the second IoT server 402b includes a second IoT adaptation capability library 404b, and the third IoT server 402c includes a third IoT adaptation capability library 404c. As shown, the first and second libraries 404a and 404b are embedded inside of the first and second adaptation services 302a and 302b, respectively. Thus, in some cases, an adaptation capability library can be embedded inside of an IoT adaptation service. In other cases, an adaptation library can be deployed as a network service itself For example, the third adaptation capability library 404c may be deployed as service in the network by the third IoT server 402c.

The IoT adaptation capability libraries 404 each include one or more IoT adaptation capabilities 406. For example, in accordance with the illustrated embodiment, the first adaptation library 404a includes first adaptation capabilities 406a, the second adaptation library 404b includes second adaptation capabilities 406b, and the third adaptation library 404c includes third adaptation capabilities 406c. While three adaptation capabilities 406 are illustrated in each library 404, it will be understood that any number of capabilities can be included in a library as desired. As used herein, a given IoT adaptation capability may refer to a particular type or form of adaptation that is supported by an IoT adaptation service that has access to the given IoT adaptation capability. For example, the capabilities 406 may be used by the adaptation services 302a and 302b to perform different types of adaptation on applications and services in the network. Example adaptation capabilities are presented and adaptation capabilities are further described below. Applications and services can discover and request a desired type of adaptation, and in particular a specific adaptation capability, that can be performed by the adaptation services 302. The libraries 404a-c can each support a set of native (built-in) adaptation capabilities 406. For example, in accordance with the illustrated embodiment, the first capabilities 406a are native to the first library 404a, the second capabilities 406b are native to the second library 404b, and the third capabilities 496 are native to the third library 404c. The libraries 404a-c can each further support links to adaptation capabilities 406 that are adaptation capability libraries that are hosted elsewhere in the network (e.g., on other IoT servers). By way of example, the first library 404a may include links to the second and third capabilities 406b and 406c that are hosted by the second and third libraries 404b and 404c, respectively. Thus, via the links for example, IoT adaptation services 302 can collaborate with one another to share their respective adaptation library and in particular the corresponding capabilities, with one another. As further described below, the libraries 404 may allow client applications and services to create and add new adaptation capabilities to the libraries 404. As shown, the first and second adaptation services 302a and 302b can access the third IoT adaptation capabilities 406c that reside in the third adaptation library 404c, which can be referred to as a standalone service because the third library 404c is not part of a larger service on the third server 402c. Thus, in some cases, IoT adaptation services can access IoT adaptation capabilities provided by standalone adaptation capability libraries that may be hosted in the network as standalone services.

Still referring to FIG. 4, the adaptation capability libraries 404 may each allow IoT applications and services to add new adaptation capabilities to ones of the IoT adaptation capability libraries 404. Thus, the scalability and flexibility of an IoT adaptation service can be greatly enhanced as compared to a service that does not add new capabilities. For example, the libraries 404 may receive requests from applications or services, and the requests may include various types of information. The requests may include an executable (e.g., binary image) of one of the adaptation capabilities 406 that an application or a service wants added to one of the libraries 404. The requests may alternatively, or additionally, include a link or a reference to one of the adaptation capabilities 406 that an application or service wants added to a library that is hosted on a network entity that is different than the network entity that receives the request. After a link or reference is received by one of the adaptation libraries 404, the adaptation capability library 404 can maintain the link or reference and use it to invoke a remote adaptation capability to have it perform an adaptation on its behalf. Alternatively, the adaptation capability library 404 can use the link or reference to fetch a copy of the adaptation capability so that the library 404 can locally host the fetched adaptation capability.

The illustrated libraries 404 may allow applications or services to discover their respective capabilities 406. For example, IoT applications and services can issue IoT adaptation service discovery requests to the adaptation libraries 404 to discover which of the adaptation capabilities 406 are supported by each of the libraries 404. Discovery, as described herein, may allow each of the IoT adaptation services 302 to publish the types of adaptation capabilities 406 that they support. As described herein, the libraries 404 may support a set of native (local) adaptation capabilities 406. The libraries 404 may further access a set of adaptation capabilities 406 of other adaptation capability libraries 404 that are hosted elsewhere in the networks. Such adaptation capabilities may be referred to as remote adaptation capabilities. Both the local or native adaptation capabilities and the remote adaptation capabilities can be made discoverable via the same discovery mechanism In one example embodiment, client applications and services can discover the capabilities 406 of the libraries 404 using remote service level procedure call requests. In response the requests, the adaptation capability libraries 404 can return a list of supported adaptation capabilities. In an alternative embodiment, client applications and services can retrieve a discovery resource representation form by client applications and services. This representation form can contain a list of adaptation capabilities 406 that are supported by respective libraries 404.

In an example embodiment, the adaptation capability libraries 404 are compatible with, for instance include, an adaptation capability discovery engine, which can also be referred to as a search engine, such that the adaptation capability libraries 404 can be queried based on search criteria. Example search criteria include, for example, keywords, attributes, or descriptions of adaptation capabilities. Based on queries, a response can be returned that contains adaptation capability discovery information. A client, such as an application or service for example, can inspect the response which may include search results to determine whether the results, and in particular the supported adaptation capabilities that are contained within the results, meets its requirements or not. For each one of the adaptation capabilities 406 that one of the libraries 404 supports, referred to generally as supported adaptation capabilities, the adaptation capability library 404 may maintain, for example store, various discovery information. Thus, each of the adaptation capabilities 406 may be associated with one or more types of information.

For example, one or more of the adaptation capabilities 406 may be associated with a unique name. The unique name may be used to discover an adaptation capability, and thus the unique name is an example of discovery information. To promote interoperability and standardization of common or general adaptation capabilities, the unique names may be registered and maintained by industry registries in accordance with an example embodiment. Example registries include the internet assigned numbers authority (IANA), the outcome and assessment information set (OASIS), or the like. Semantic descriptions of input and output parameters of the adaptation capabilities 406 may be used to discover adaptation capabilities, and thus are examples of discovery information. The semantic descriptions can be stored and maintained by the adaptation capability library 404 that hosts the capabilities 406 described by the semantic descriptions. Storing discovery information within the library that hosts the capability associated with the discovery information may be referred to as local storage. Alternatively, or additionally, the semantic descriptions may be stored somewhere in the network besides the adaptation capability library 404 that hosts the capabilities 406 described by the semantic descriptions. Such storage of discovery information may be referred to as remote storage. For example, semantic descriptions may be stored in a semantic server or in another remote adaptation capability library. If stored remotely, for example, in a remote adaptation capability library that does not host the capability associated with the semantic descriptions, the remote adaptation capability library can maintain links or references to the semantics descriptions.

The semantic descriptions may include various information, such as, for example and without limitation, information that describes what it is to be adapted. This information may include, for example, a structure or format of an information element that is to be adapted, or a particular portion or feature of an application or service that is to be adapted. It will be understood that other information that describes what is to be adapted may be included in the semantic descriptions as desired. The structure or format of an application or service that is to be adapted may be based on content, policy, an event, or a context structure. Semantic descriptions may further include information that indicates when the adaptation is to take place, such as adaptation criteria or policies that define conditions for when the adaptation is to be performed. Semantic descriptions may further include information that describes how the adaptation is to be performed. This information may include, for example, a name of one or more adaptation capabilities that are leveraged/referenced by the capability described by the semantic descriptions. One or more adaptation capabilities may be leveraged or referenced by a particular capabilities in order to perform an adaptation. Information that describes how the adaptation is to be performed may further include an order in which one or more adaptation capabilities may be executed, the manner in which the one or adaptation capabilities will be applied to the adaptation target(s), or the like. For example, one adaptation capability may be used to adapt a certain aspect of the target and another may be used to adapt another aspect of the target. Semantic descriptions may further include information that indicates an output of the adaptation capability. The output may refer to the structure of an adapted information element, the behavioral modification performed on an application or service, or the like. It will be understood that the semantic descriptions may include other information that indicates other aspects of a desired adaptation capability as desired.

As described above, various instances of IoT adaptation services, for instance the first and second IoT adaptation services 302a and 302b depicted in FIG. 4, may collaborate with each other in a network. Examples of collaboration are described below, though it will be understood that IoT adaptation service collaboration is not limited to the examples described below.

IoT adaptation services, such as the IoT adaptation services 302a and 302b, may collaborate with each other to exchange discovery information, such as types of adaptation capabilities that are supported by each of the IoT adaptation services 302a and 302b for example. In an example embodiment, an IoT adaptation service instance uses collaboration to discover the adaptation capabilities of other IoT adaptation service instances in the network. Such adaptation capabilities for IoT adaptation service instances in the network may be referred to as remote adaptation capabilities. The IoT adaptation service instance may advertise remote adaptation capabilities to its clients using the adaptation capability library discovery mechanisms described above. In doing so, clients can discover native adaptation capabilities supported by the adaptation service and remote adaptation services supported by the adaptation service's collaboration partners, for example.

IoT adaptation services, such as the IoT adaptation services 302a and 302b for example, may collaborate with each other to exchange adaptation capabilities. Thus, adaptation capabilities may be shared between a plurality of adaptation services in accordance with an example embodiment. In one embodiment, copies of adaptation capabilities are shared between IoT adaptation service instances. In another embodiment, an IoT adaptations service shares links to its adaptation capabilities that can be referenced to remotely call or invoke these adaptation capabilities hosted on other IoT adaptation service instances in the network. Via such collaboration, for example, an IoT adaptation service can offer a broad set of adaptation capabilities to its clients.

In accordance with an example embodiment, IoT adaptation services may collaborate with each other to offload adaptation operations from one IoT adaptation service to another IoT adaptation service. For example, an overloaded IoT adaptation service may offload an adaptation operation to another IoT adaptation service that supports one or more adaptation capabilities that are necessary to perform the offloaded adaptation operation. The results of the adaptation operation, which can be referred to as adaptation results, can then be returned to the overloaded IoT adaptation service. Thus, the overloaded IoT adaptation service may send the results to the client, for example an application or service that requested the adaptation operation.

IoT adaptation services, such as the IoT adaptation services 302a and 302b for example, may collaborate with each other to share information. For example, shared information may be used by the IoT adaptation services to make decisions or determinations. In some cases, an IoT adaptation service shares context related information with one or more other IoT adaptation services. An example of context related information that a given adaptation service may share is a number of clients that are currently using or subscribing to the given adaptation service. Such clients may be referred to as active clients. By sharing the number of active clients, the given adaptation service may determine that it has more active clients than another IoT adaptation service. Based on this determination, adaptation operations for the given adaptation service may be offloaded to the other IoT adaptation service that has less active clients than the given IoT adaptation service. Similarly, clients themselves may be offloaded to other IoT adaptation services that support the adaptation operations of the clients. Thus, clients and/or adaptation operations may be transferred between one or more adaptation services to balance loads on the one or more adaptation services in a network. In another embodiment, IoT adaptation service instances can share adaptation decision making policies with one another so as to align their adaptation decisions. In yet another embodiment, IoT adaptation services can share events with each other, such as the detection of an IoT adaptation service instance joining or leaving the network for example. Thus, by collaborating and sharing information with one another, one or more IoT adaptation service instances in a network can operate more efficiently and effectively.

The above examples of IoT adaptation service collaboration can be implemented by the IoT adaptation services exchanging collaboration requests and responses between each other in network. Various example collaboration requests and responses are described below, though it will be understood that other requests and response may be used as desired.

In an example embodiment, an IoT adaptation service instance, such as the adaptation service 302 for example, can send a request to another IoT adaptation service instance or a group of IoT adaptation service instances to establish an adaptation collaboration session. Such a request may be referred to as an adaptation collaboration association request. The adaptation collaboration session may establish a secure communication connection between IoT adaptation service instances such that the adaptation services can perform the different types of adaptation collaboration described herein. The adaptation collaboration association request may be followed by response that may be referred to as an adaptation collaboration association response. The request and response may contain, for example, adaptation service identifiers and security credentials that are used for authentication of the adaptation service that are collaborating with each other. The adaptation collaboration association requests and responses may further contain an adaptation collaboration session identifier.

After a collaboration association has been established between a plurality of adaptation service instances, for example the first and second adaptation services 302a and 302b, one of the first and second adaptation services may send a request to the other of the first and second adaptation services to negotiate types of adaptation collaboration that the adaptation service instances will allow with each other. Such a request may be referred to as an adaptation collaboration negotiation request. A response to the adaptation collaboration negotiation request may be referred to as an adaptation collaboration negotiation response. The adaptation collaboration negotiation request and response may contain, for example and without limitation, an adaptation collaboration session identifier list. Such a list may include one or more desired forms of adaptation collaboration that the requester is requesting be enabled for the given adaptation collaboration session. An example response includes a list of one or more forms of adaptation collaboration that have been approved for the session.

Further, after a collaboration association has been established between a plurality of adaptation service instances, for example the first and second adaptation services 302a and 302b, one of the first and second adaptation services may send a request to the other of the first and second adaptation services. The request may be a request for a specific type of adaptation collaboration. Such a request may be referred to as an adaptation collaboration request. A response to the adaptation collaboration request may be referred to as an adaptation collaboration response. The adaptation collaboration request and response may contain various information such as, for example, a type of adaptation collaboration being requested; a binary image of one or more adaptation capabilities; links/references to one or more adaptation capabilities; one or more types of adaptation operations to be performed; targeted information elements (or links to information elements) to perform adaptation upon (e.g., content, policies, etc.); links, addresses, identifiers of targeted applications, services, entities in the network to perform adaptation upon; information to be factored into adaptation operations and decisions making (context, policies, events, semantics, etc.); and adaptation results or statuses.

An adaptation collaboration de-association request and response may be exchanged between a plurality of IoT adaptation service instances. For example, one adaptation service may send the adaptation collaboration de-association request to another IoT adaptation service instance or to a group of IoT adaptation service instances to tear-down an existing adaptation collaboration session. This response and request may contain, for example, an adaptation collaboration session identifier.

In accordance with an example embodiment, an IoT adaptation service subscription enables instances of IoT adaptation services, applications, and other services to subscribe to an IoT adaptation service instance in the network to receive adaptation services from the IoT adaptation service. Clients, such as applications or services for example, that subscribe to an adaptation service may define adaptation subscription criteria. Such criteria may specify conditions for which adaptation is to be performed by the adaptation service to which the client subscribes. In one embodiment, a client that subscribes to an adaptation service can specify a set of adaptation policies as the subscription criteria. The adaptation service can evaluate the specified set of adaptation policies, and based on the specified set of policies, the adaptation service can determine whether to perform an adaptation for the client.

An example IoT adaptation service may send adaptation notifications to clients that subscribe to the example adaptation service. Further, the client, via its subscription to the adaptation service for example, may specify one or more adaptation targets, such as applications, services, or the like. The specified adaptation targets may receive notifications when adaptation criteria is met that may be specified by the client, which may be referred to as a subscriber. Such notifications can be used, for example, to notify clients or targets how they should adapt themselves. Example notifications can notify the subscribing clients or targets that they need to make a call-back request to the IoT adaptations service to have a specified type of adaptation performed. Notifications may contain contact information of one or more other services in the network that the subscribing clients or targets should contact. Notification can further contain adapted information for the clients or target. The adapted information may adapt the clients or targets. An example of adapted information that may be sent to clients or targets in a notification includes an adapted policy. The adapted policy may adapt behavior of the clients or targets.

As described above, notifications can notify the subscribing clients or targets that they need to make a call-back request to the IoT adaptations service. For example, the IoT adaptation service may include a call-back request in a notification that the adaptation service sends to subscribing clients or targets. The call-back request may be sent to subscribing clients or targets in responses to respective subscription criteria being met. In a one embodiment, the adaptation service includes a capability that can receive call-backs. In another embodiment, the adaptation service includes a RESTful resource that can receive PUT or POST requests. The capability and the resource that can receive call-backs can each be referred to as an adaptation call-back. When a client or target receives a notification containing a reference to the adaptation call-back, the client or target can make a subsequent request to the adaptation call-back. The IoT adaptation service may in turn service the subsequent request and perform the specified type of adaptation that may have been originally specified in the subscription.

The above examples of IoT adaptation service subscriptions can be implemented by an example IoT adaptation service, for instance the adaptation service 302, receiving and sending subscription requests and subscription responses. Various example subscription requests and responses are described below, though it will be understood that other requests and response may be used as desired.

In an example embodiment, a client, such as an application or service for example, can send an adaptation service subscription request to a particular adaptation service. The adaptation service subscription request may be a request to subscribe to one or more adaptation capabilities that are supported by the adaptation service. As used herein, an adaptation capability may be supported by an adaptation service if the adaptation services has access to the adaptation capability. The adaptation service may respond to the adaptation service subscription request, and such a response may be referred to as an adaptation service subscription response. The adaptation service subscription request and response can contain various information. By way of example and without limitation, the requests and responses may contain: a list of one or more adaptation subscription criteria; a list of one or more adaptation targets for the service to perform adaptation upon; a list of one or more particular types of adaptation capabilities that the subscribing client would like the adaptation service to use when performing the adaptation on the specified target(s); and/or a type of adaptation notification that the client/target is to receive if/when the adaptation subscription criteria are met. Targets can include the subscribing client as well as information elements, resources, applications, services, network entities, or the like.

An IoT adaptation service instance, such as the adaptation service 302 for example, may send an adaptation service notification request to one or more clients or targets that subscribe to the adaptation service. The notification request may be sent when adaptation subscription criteria that corresponds to the clients or targets are met. The clients or targets may respond to the adaptation service notification request, and such a response may be referred to as an adaptation service notification response. The notifications requests and responses can contain various information. By way of example and without limitation, the notification requests and responses may contain: a reference to an adaptation call-back of the IoT adaptation service; adapted information (e.g., content, policy, context, event, etc.); a list of one or more services in the network that the client/target should contact; and/or a list of instructions for the clients or targets to perform adaptation on themselves.

Referring generally to FIG. 4, the IoT adaptation capabilities 406 may each represent a particular type or form of adaptation supported by at least one of the IoT adaptation services 302a and 302b. The adaptation capabilities 406 are broad and generic in nature, and thus the adaptation capabilities 406 are not customized to a particular application or service. Thus, the capabilities 406 can be offered by the adaptation services 302a and 302b as general adaptation capabilities 406 that can be used by a broad heterogeneous set of applications and services in the network. Further, the adaptation capabilities 406 may differ from customized forms of adaptation that are performed by applications instead of network services, such as the adaptation services 302 for example.

The IoT adaptation capabilities 406 may be aware of various content, such as semantic information for example. Semantic information can be provided as input to one of the adaptation services 302. For example, semantic information can be included in a client's adaptation request. Alternatively, semantic information may be dynamically retrieved by the IoT adaptation service 302 from other entities in the network. Such other entities (e.g., semantic servers) may host semantic information. Using semantics, for example, the IoT information adaptation capabilities 406 can parse and understand content. This awareness of content may enable the IoT information adaptation capabilities 406 to support general content adaptation services.

The IoT adaptation capabilities 406 may be further aware of adaptation context information. Adaptation context information can be provided as input to one of the adaptation services 302. For example, context information may be included in a client's adaptation request. Alternatively, context information can be dynamically retrieved or collected by the IoT adaptation service 302. In one embodiment, the IoT adaptation service 302 can retrieve context information from other entities in the network, such as context brokers for example. In another embodiment, the IoT adaptation service 302 can collect its own context information. For example, the IoT adaptation service 302 may collect a number that represents the number of clients being serviced by the IoT adaptation service 302 at any given time. The IoT adaptation service 302 may collect a number that represents the number of available adaptation service instances in the network. The IoT adaptation service 302 may further collect information associated with the available adaptation service instances, such as loading characteristics associated with each available service instance and capabilities that each of the available service instances support. To parse and understand context information, the IoT information adaptation capabilities 406 may rely on context semantics, which may be similar to content semantics. In accordance with one embodiment, context semantics are included as inputs in a request or are retrieved from other entities in the network. In another example embodiment, policies are pushed to the IoT adaptation service 302 by other entities in the network, such as management functions, other services, applications, or the like. Using context information, the IoT information adaptation capabilities 406 can intelligently make adaptation decisions. Example adaptation decisions that each adaptation capability 406 may perform include when to perform adaptation itself and when to offload adaptation to another adaptation service in the network.

The IoT information adaptation capabilities 406 may be aware of one or more adaptation policies. Adaptation policies can be provided as input to one of the adaptation services 302. For example, adaptation policies may be included in a client's adaptation request. Alternatively, adaptation policies can be dynamically retrieved or collected by the IoT adaptation service 302. In one embodiment, the IoT adaptation service 302 can retrieve context information from other entities in the network, such as policy brokers for example. In another embodiment, policies can be pushed to the IoT adaptation service 302 by other entities in the network, such as management functions, other services, applications, or the like. The IoT adaptation service 302 can also support generating its own policies, for example, based on existing policies and context information that the adaptation service 302 may access. By leveraging their content awareness, context awareness, policy awareness, and IoT information, the adaptation capabilities 406 can make cognitive decisions regarding adaptation of information.

Referring generally to FIG. 4, the IoT adaptation capabilities 406 may include various types of capabilities, some of which are described below by way of example. In accordance with various example embodiments, the adaptation capabilities 406 may be deployed as general forms of adaptation that can be supported by one or more IoT adaptation services. Ones of the adaptation capabilities 406 may adapt information, and such adaptation capabilities may be referred to information adaptation capabilities. Information that can be adapted by the information adaptation capabilities include, for example, content, context, semantics, policies, events, and decision-related information.

Example IoT information adaptation capabilities, such as ones of the adaptation capabilities 406 for example, may intelligently adapt a format of information. For example, ones of the adaptation capabilities 406 may change information from one format to another. Changing the format may be based on parsing and understanding an original information format that includes a set of corresponding semantics, which may be referred to as a first set of semantics. The original information format may be translated to comply with a target set of semantics, which may be referred to as a second set of semantics. In some cases, information can be adapted based on available context that is related to the information being adapted. For example, the information can be compressed if it is going to be sent over or through a network containing resource constrained devices or limited bandwidth.

Example IoT information adaptation capabilities, such as ones of the adaptation capabilities 406 for example, may intelligently adapt a location of where information is hosted or stored in a network. For example, the adaptation capabilities 406 may include a capability to move information within the network based on various data. In some cases, information is moved closer to one or more entities that are requesting the information. Such entities may be referred to as requesters. In some cases, information is moved to reduce network congestion. In other cases, information is moved because a request of the information is moving or has moved within the network, and thus information may be moved based on a moving requester. It will be understood that information may be moved based on other factors as desired.

Example IoT information adaptation capabilities, such as ones of the adaptation capabilities 406 for example, may intelligently adapt information that is contained within a particular instance of information that is hosted or stored in a network. Examples of such adaptation include, for example, enriching existing information instance(s) with additional information, merging information instances together to form higher-level information, splitting information instance(s) to form lower-level information, or filtering information instance(s) to remove information that is no longer valid or required.

Example IoT information adaptation capabilities, such as ones of the adaptation capabilities 406 for example, may intelligently adapt one or more network entities that generate a particular type of information in order to modify future information instances produced by the one or more network entities. By way of example, adaptation capabilities 406 may adapt how information is generated (e.g., the generating procedure or service), adapt the format of the generated information (e.g., semantics, encoding, etc.), adapt the schedule of when information is generated, adapt network entities with which information is shared, or adapt the network location(s) where the information is stored upon generation.

Example IoT information adaptation capabilities, such as ones of the adaptation capabilities 406 for example, may intelligently adapt a flow or distribution of information through a network. The adaptation capabilities 406 may adapt requests for information. For example, adaptation capabilities 406 may adapt particular types of instances of information such that the information is directed to appropriate entities in the network.

Example IoT information adaptation capabilities, such as ones of the adaptation capabilities 406 for example, may intelligently adapt one or more access rights pertaining to information. By way of example, the access rights of information instances may be adapted to control who accesses the information from a security perspective. Access rights may also be adapted to control how many requesters are allowed to simultaneously access the information from a load balancing or performance perspective. Example IoT information adaptation capabilities may also adapt ownership or managerial rights of the information. For example, an adaptation capability may change which network entity and/or application is responsible for controlling and managing the information.

Example IoT information adaptation capabilities, such as ones of the adaptation capabilities 406 for example, may intelligently adapt discovery information for an information instance in the network. In one embodiment, the creation, update, modification, and removal of discovery information in the network related to the information instances is adapted by one of the adaptation capabilities 406. The adaptation capabilities 406 may adapt the relationships or dependencies between information instances in the network. Thus, for example, the relationships or dependences between events, content, policies, decisions, or the like may be changed by adaptation capabilities 406. In one embodiment, information is linked with parent information elements from which the information was derived (e.g., a policy) or child information elements which the information spawned (e.g., an event). The adaptation capabilities may further intelligently adapt one or more policies or rules that are contained within a particular information instance stored in the network.

Still referring generally to FIG. 4, the IoT adaptation capabilities 406 may include adaptation capabilities that are used to adapt IoT applications, services, or other entities, such as devices, routers, gateways, servers, the like. Such adaptation capabilities may be referred to generally as entity adaptation capabilities. Entity adaptation capabilities may be enabled or enhanced by features described herein, for example, the IoT adaptation service subscription, the IoT adaptation service collaboration, content awareness, context awareness, policy awareness, and cognitive decision making mechanisms.

In an example embodiment, a client (e.g., application or service) or other network entity can subscribe an entity adaptation capability (via its associated IoT adaptation service) to receive adaptation notifications. The entity adaptation capability can in turn send notifications to adapt the client or entity that has subscribed to it. The notifications can contain information that the client or entity can use to perform self-adaptation (e.g., network-based context, events, policies, etc.). Alternatively, the IoT adaptation service can issue adaptation commands to a client or entity via a subscription notification or via an explicit request, or the adaptation service provide a call-back reference for the client or entity to use, as described above. The IoT entity adaptation capability can collaborate with other services in the network to assist it with adaptation (e.g., indirectly issue requests to applications via software defined services). The adaptation command can instruct the client or entity to perform different types of adaptations. Various example entity adaptation capabilities are described below. It will be understood that the described entity adaptation capabilities are presented by way of example, and without limitation.

Example IoT entity adaptation capabilities, such as ones of the adaptation capabilities 406 for example, may adapt a network entity by virtualizing the network entity within a network. For example, if the number of requests targeting a resource constrained IoT device is overwhelming the resource constrained IoT device, the IoT adaptation service 302 can detect that the scenario in which the device is overwhelmed by monitoring network context information. The adaptation service 302 may proactively and autonomously adapt the overwhelmed IoT device, for example, by virtualizing its applications, services, resources, information, or the like, within the network. In doing so, the network can service requests to the IoT device on its behalf Thus, the network may be a proxy for the IoT device. The IoT adaptation service 302 can collaborate with virtualization services in the network to assist it with this virtualization. This differs from other IoT device virtualization services that do not support dynamic adaptation of virtualization policies for IoT devices. Other IoT device virtualization services may rely on explicit requests from the IoT device themselves or from proxies on their behalf to request that the virtualization service performs IoT device virtualization (e.g., ETSI M2M service layer virtualization of IoT devices).

Example IoT entity adaptation capabilities, such as ones of the adaptation capabilities 406 for example, may adapt one or more virtualization capabilities of an entity, such as an application or service for example. Such adaptation can be used to control the virtualization actions performed by the entity. For example, the virtualization capabilities of an example entity can be dynamically adapted to control what the entity virtualizes, if/when the entity performs virtualization, and how the entity performs virtualization. By way of further example, virtualization policies can be dynamically adapted to address undesirable conditions that are not being addressed by current policies. In one embodiment, a client, such as an application or service for example, subscribes to an example adaptation service and receives adaptation notifications if and when it should adapt its virtualization policies based on observed context that the adaptation service detects or is provided with. For example, notifications may be based on context information that a particular IoT device is overloaded and cannot keep up with the number of requests being targeted to it. In this case, for example, the adaptation service can dynamically adapt the virtualization service's policies to have it virtualize the IoT device in order to offload the IoT device from having to service the requests itself

Example IoT entity adaptation capabilities, such as ones of the adaptation capabilities 406 for example, may adapt one or more networking entities that host a particular service or application. For example, an example service or application instance can be moved or copied from one network entity to another based on context and policy-based cognitive decision making, effectively adapting the host of the service or application. By way of further example, a service or application instance can be dynamically moved to different servers in the network which physically reside in a location that is in closer proximity to clients requesting to use the service. In doing so, for example, improved quality of service (QoS) can be provided to the clients and loading on the network can be reduced.

Example IoT entity adaptation capabilities, such as ones of the adaptation capabilities 406 for example, may adapt a priority of the entity with respect to other entities hosted in the network. A higher or lower priority can be configured with respect to network resources that are made available to the example entity. Example network resources include, without limitation, computing resources, network bandwidth, data storage capacity, or the like. For example, network and/or service providers can offer different rate plans to its customers for which it can manage and adjust the priority of how the customer's requests are serviced.

Example IoT entity adaptation capabilities, such as ones of the adaptation capabilities 406 for example, may adapt one or more targeted network entities, services, or peer applications with which an entity interacts or collaborates. For example, the IoT adaptation service 302 can instruct a client to use a new network address for a mobile network entity that moves and obtain the new network address. Alternatively, for example, the IoT adaptation service 302 can instruct a client to use a different host for a service within the network if the current host becomes overloaded or encounters a problem.

Example IoT entity adaptation capabilities, such as ones of the adaptation capabilities 406 for example, may adapt a flow or distribution of client requests or client responses through a network. An example adaptation capability adapts which entities in the network particular types of service requests or responses are directed to. In doing so, for example, loading on network resources can be better managed. Further, the network can maximize opportunities for intermediate nodes in the network to perform caching and aggregation by intelligently controlling the routes that requests, responses, and information use to flow through the network.

Example IoT entity adaptation capabilities, such as ones of the adaptation capabilities 406 for example, may adapt access rights pertaining to a client, such as an application or a service or other network entity for example. Access rights to an application, server, or network entity can be adapted to control which entities can generate requests to the application, server, or network entity. For example, access rights can be used from a security perspective or from a performance and scalability throttling perspective (e.g., to control the number of simultaneously service requests and a flow through the network). An example IoT entity adaptation capability further adapts ownership or managerial rights of an entity, such as an application or service for example. The example IoT entity adaptation capability may adapt which network entity is responsible for controlling and managing another network entity, such as an application or service for example. For example, access rights can be created, updated, changed, removed, and/or managed.

Example IoT entity adaptation capabilities, such as ones of the adaptation capabilities 406 for example, may adapt one or more networking entities so that respective discovery information is also changed. For example, as an example network is adapted, its discovery information can also be adapted to reflect any changes to the network entity. An example IoT entity adaptation capability may adapt services or applications hosted on a network entity. For example, the network entity can be adapted by creating new services or applications on the entity or by removing services or applications from the entity. Services or applications that are removed may be services or applications that are no longer needed or services or applications that are transferred to another entity in the network. Similarly, an entity can be adapted by modifying one or more existing services or applications already hosted on the entity. For example, an example entity adaptation capability may adapt a service to modify its inputs, outputs, or the functionality of the service itself. A service can be further modified to change the other services in the network with which it collaborates, or a service can be modified to change how the service interacts with cloud-base resources or the like. In an example embodiment, the rate at which a client, such as an application for example, makes requests to a network is adapted by an adaptation capability. Further, an adaptation capability may change a size of requests.

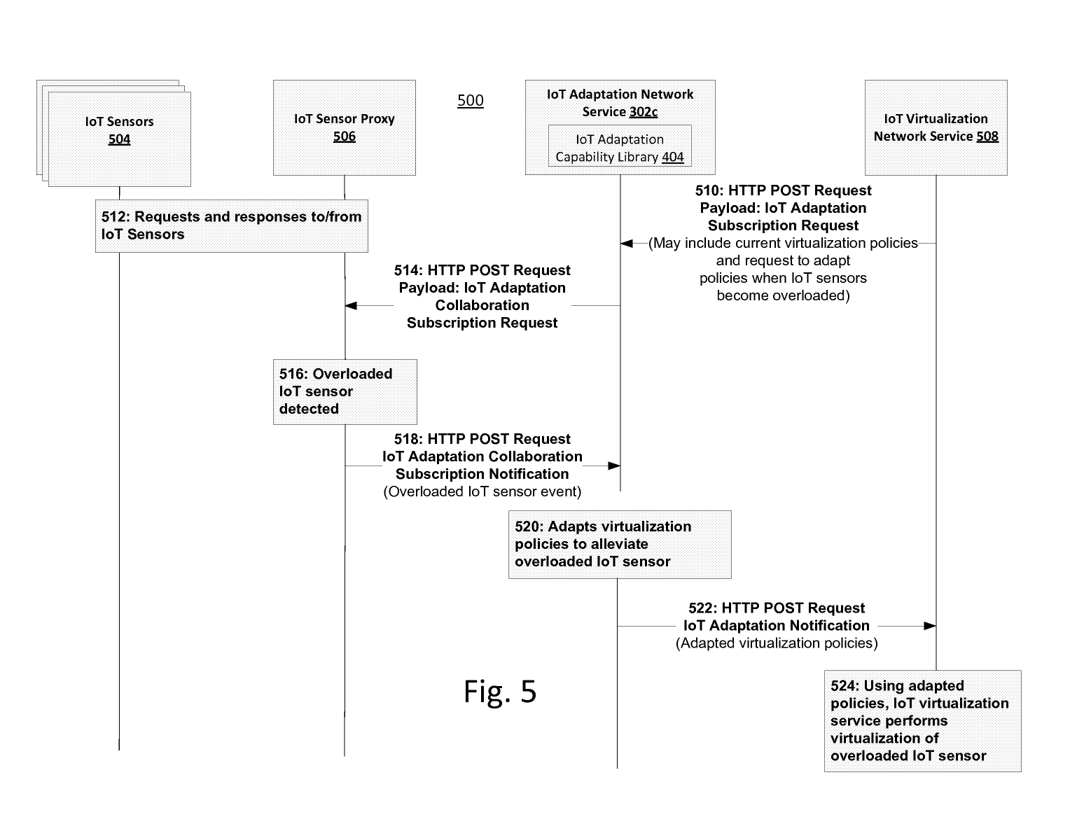

Referring now to FIG. 5, an example system 500 may include at least one of the above-described IoT adaptation services 302, such as an IoT adaptation network service 302c. The system 500 further includes one or more IoT sensors 504, an IoT sensor proxy 506, and at least one of the services 306, such as an IoT virtualization network service 508. The adaptation service 302c, the one or more sensors 504, the sensor proxy 596, and the virtualization network service may communicate with each other in a network. The IoT adaptation service 302c may include one of the IoT adaptation capability libraries 404. It will be appreciated that the example system 500 is simplified to facilitate description of the disclosed subject matter and is not intended to limit the scope of this disclosure. Other devices, systems, and configurations may be used to implement the embodiments disclosed herein in addition to, or instead of, a system such as the system 500, and all such embodiments are contemplated as within the scope of the present disclosure.

In accordance with the illustrated embodiment, the IoT adaptation service 302c is virtualized such that it hosted in the network, such as on a network server or cloud server for example, and the IoT virtualization service 508 that is also hosted in the network may subscribe to the adaptation service 302c. As described below, FIG. 5 illustrates an example direct request for adaptation services. The illustrated embodiment uses the HTTP protocol as an underlying transport to carry IoT adaptation service requests and responses within HTTP message payloads, although it will be understood that other protocols may be used by the IoT adaptation service 302c as desired.

With continuing reference to FIG. 5, in accordance with the illustrated embodiment, at 510, the IoT virtualization service 508 subscribes to the IoT adaptation service 302c. At 510, the IoT virtualization service 508 may send an HTTP Post request that includes an IoT adaptation subscription request. The subscription request may indicate a network policy of the IoT virtualization network service 508. For example, the adaptation subscription request may include one or more virtualization policies of the virtualization service 508. The request may further include a request that the adaptation network service 302c adapt the one or more virtualization policies of the virtualization network service 508 when one of the IoT sensors 504 in the network is detected as being overloaded. At 512, the IoT sensor proxy 506, which may also be referred to as a sensor service 506, sends requests to the sensors 504 and receives responses from the sensors 504 in order to detect when the IoT sensors 504 become overloaded. For example, the IoT sensor proxy 506 can track a rate that indicates how many requests have been issued to ones of the IoT sensors 504 without receiving a response. If the rate associated with a particular sensor exceeds a predetermined threshold, for example, the IoT sensor proxy 504 can determine that the particular IoT sensor is overloaded. At 514, the IoT adaptation service 500 collaborates with the proxy 506 to receive events if and when ones of the IoT sensors 504 becomes overloaded. For example, at 514, the adaptation service 302c may send an HTTP POST request to the proxy 506. The request may be a request to subscribe to the sensor proxy 506 such that the adaptation service receives an indication when events occur, such as one of the sensors 504 being overloaded.

Sill referring to FIG. 5, at 516, in accordance with the illustrated embodiment, the IoT proxy 506 detects that one of the sensors 504 is overloaded IoT. At, 518 the proxy 506 sends an event notification to the IoT adaptation service 302c. The event notification notifies the adaptation service 302c that one of the IoT sensors 504 is overloaded. Thus, the event notification is indicative of a status of an IoT device, in particular one of the sensors 504. In accordance with the illustrated example, the event notification indicates that the sensor 504 is overloaded. At 520, based on the event notification, the IoT adaptation service 302c adapts the one or more polices of the virtualization service 508 to lessen the load on the sensor 504 that is overloaded. For example, the rules defined within the policy (e.g., under what conditions to perform virtualization) can be adapted by the adaptation service 302c. Changing the rules may change the behavior of the virtualization service 508. For example, the rules may be changed such that the loading threshold of the overloaded sensor 504 is lowered. At 522, the adaptation service 302c sends a notification that includes the adapted policies to the IoT virtualization service 508. Thus, the adaptation service 302c may generate instructions, which may be referred to as first instructions, that include an adapted version of the network policy so that a network entity can perform the virtualization service 508 for the overloaded IoT device 504. At 524, the IoT virtualization service 508 uses the adapted policies, which can also be referred to as new policies, to determine that it should virtualize the overloaded IoT sensor 504. Once virtualized, the IoT sensor 504 may no longer need to process requests. The proxy 506 may service requests on behalf of the IoT sensor 504 because the IoT sensor 504 is virtualized. As a result, for example, the load on the overloaded sensor is reduced. Thus, in accordance with the illustrated embodiment, the IoT virtualization service's subscription request includes its virtualization policies as the criteria. For example, if the adaptation service 302c detects overloaded IoT sensors in the network, then it is to update the virtualization policies such that the virtualization service will virtualize the overloaded IoT sensors to reduce their loading. Thus, the IoT adaptation service 302c can intelligently decide if and when to adapt the policies of the virtualization service 508.

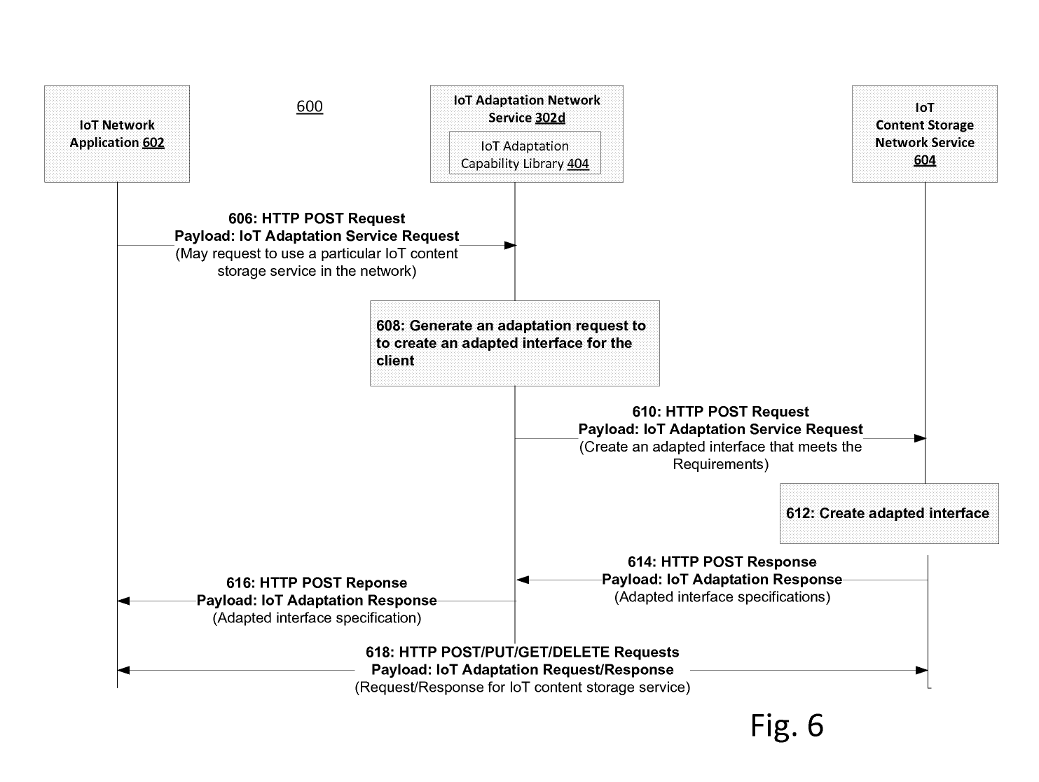

Referring now to FIG. 6, an example system 600 may include at least one of the above-described IoT adaptation services 302, such as an IoT adaptation network service 302d. The system 600 includes at least one of the IoT network applications 310, such as an IoT network application 602. As illustrated, the system 600 further includes at least one of the network services 306, such as an IoT content storage network service 604. The adaptation service 302d, the network application 602, and the content storage network service 604 may communicate with each other via a network. The IoT adaptation service 302d may include one of the IoT adaptation capability libraries 404. The application 602 and the service 602 may be referred to generally as clients or network entities. It will be appreciated that the example system 600 is simplified to facilitate description of the disclosed subject matter and is not intended to limit the scope of this disclosure. Other devices, systems, and configurations may be used to implement the embodiments disclosed herein in addition to, or instead of, a system such as the system 600, and all such embodiments are contemplated as within the scope of the present disclosure.

Still referring to FIG. 6, in accordance with the illustrated example, the IoT application 602 that may be hosted on a network server would like to use the IoT content storage service 604 that may be hosted on another server in the network. The IoT application 602 may desire to use the content storage service 604 to offload storage of its content. For example, the IoT content storage service 604 may have an interface that is not compatible with an interface of the IoT application 602. To overcome this incompatibility, for example, the IoT application 602 may use the IoT adaptation service 302d. In doing so, the IoT adaptation service 302d is able to adapt the IoT content storage service 604 to support an interface that is compatible with the IoT application 602. As a result, for example, the IoT application 602 is able to use the IoT content storage service 604 and the IoT content storage service 604 is able to increase the number of applications using it.

FIG. 6 is a call flow that includes an indirect request for adaptation services according to an example embodiment. While the illustrated embodiment uses the HTTP protocol as an underlying transport to carry the IoT adaptation service requests and responses within HTTP message payloads, it will be understood that embodiments are not limited to using the HTTP protocol. In accordance with the illustrated embodiment, at 606, the IoT network application 602 sends an indirect adaptation request to the adaptation service 302d. The application 602 requests that the adaptation service 302d perform adaptation on the IoT content storage service 604 that is hosted in the network. The request may be referred to as an indirect request because the one entity (application 602) is requesting adaptation of another entity (content storage service 604). The request is for the adaptation service 302d to adapt the interface of the content storage service 604 such that it is compatible with the interface of the application 602. The request may include an interface description of the application 602. The interface description may include interface requirements for communicating with the application 602. At 608, the IoT adaptation service 302d creates an adaptation request for the IoT content storage service 604. The adaptation request requests that the content storage service 604 create an adapted interface that meets the requirements of the application 602. By way of example, the application 602 can provide an interface description (e.g., semantic description of interface) with which it is compatible, to the adaptation service 302d. The adaptation service 302d can pass this description within the adaptation request it sends to the content storage service 604. The content storage service 604 can use the interface description to dynamically add a compatible interface to the application 602. For example, referring to FIG. 6, at 610, the adaptation request is sent to the IoT content storage service 604. Further included in the request, for example, is the type of desired adaptation for the content storage service 604 to perform (e.g., interface adaptation) and a description of the application's interface. At 612, the IoT content storage service 604 creates a an adapted interface, which may also be referred to as a new interface, that is adapted to the interface requirements of the IoT application 602. At 614, an IoT adaptation response is returned to the IoT adaptation service 302d. At 616, the adaptation service 302 sends a corresponding response to the IoT application 602. The responses at 614 and 616 may include specifications for the adapted interface. Further, for example, the responses at 614 and 616 may include contact information, such as address and an interface description for example, that the application 602 can use to communicate with the service 604, which can be referred to as an adapted IoT service 604. At 618, the application communicates and uses the adapted IoT content storage service.

Thus, a network entity (e.g., content storage service 604) may have an interface that is non-compatible with a first client, such as the application 602 for example. An adaptation request that is associated with the first client may be received by a network server that hosts the adaptation service 302d. The request may include a request to adapt the service 604 provided by the network entity such that the first client can access the network entity. For example, the adaptation request that is associated with the first client may include interface requirements of the first client. The network server that hosts the adaptation service 302d may generate instructions, which may be referred to as first instructions, for the network entity that hosts the service 604 to adapt the service 604 such that the service 604 is compatible with the first client (e.g., application 604). The first instructions may include an adapted interface that meets the interface requirements of the first client. Further, the first instructions may include a type of adaptation for the network entity to perform and an interface description of the first client. The network server that hosts the adaptation service 302d may retrieve a plurality of adaptation capabilities 406 to perform a plurality of adaptation services 302. For example, at least one of the adaptation capabilities 406 may retrieved from the adaptation capability library 404 that may be stored at the network server that hosts the adaptation service 302d. Alternatively, or additionally, at least one of the adaptation capabilities 406 may be retrieved from library stored at another network server.

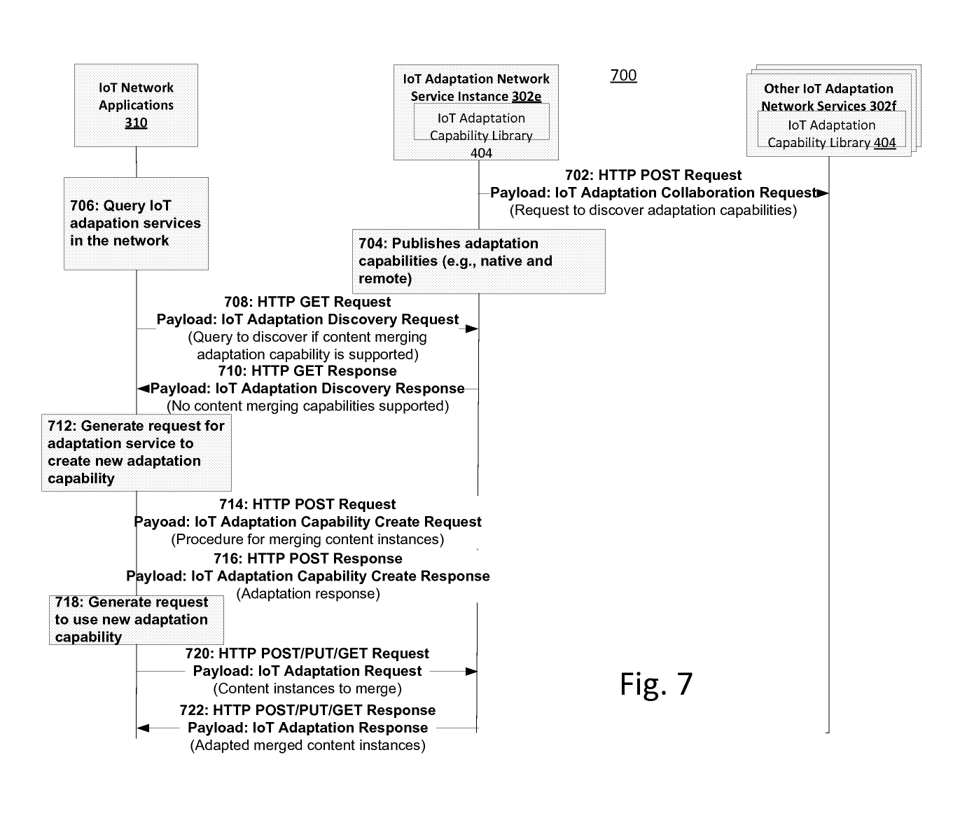

Referring now to FIG. 7, an example system 700 may include at least one of the above-described IoT adaptation services 302, such as a first IoT adaptation network service 302e. The system 700 includes a plurality of the IoT network applications 310 and at least one other adaptation service 302, such as one or more second IoT adaptation network services 302f. The first and second adaptation services 302e and 302f, and the network applications 310 may communicate with each other via a network. The first IoT adaptation services 302e and the one or more second IoT adaptation services 302f may each include one of the IoT adaptation capability libraries 404. It will be appreciated that the example system 700 is simplified to facilitate description of the disclosed subject matter and is not intended to limit the scope of this disclosure. Other devices, systems, and configurations may be used to implement the embodiments disclosed herein in addition to, or instead of, a system such as the system 700, and all such embodiments are contemplated as within the scope of the present disclosure.

Still referring to FIG. 7, one of the IoT applications 310 may desire to adapt at least two instances of content by merging them into a single instance based on a defined adaptation procedure. Such merging may be referred to as a merging operation. For example, the application 310 may be hosted on a resource constrained IoT device, and the application 310 may intend to repeatedly perform the merging operation on a large number of content instances. Thus, the application 310 may desire to use an adaptation service hosted in the network to perform this merging operation, which may be referred to generally as an adaptation, rather than perform it locally. In some cases, the IoT application 310 may be unable to find an adaptation service in the network that meets its needs. Thus, the application 310 requests that a new adaptation capability is created within an existing adaptation service, as described above. The illustrated embodiment uses the HTTP protocol as an underlying transport to carry the IoT adaptation service requests/responses within HTTP message payloads, although it will be understood that other protocols may be used as desired.

With continuing reference to FIG. 7, at 702, the first IoT adaptation service 302e collaborates with the one or more second instances of adaptation services 302f in the network by sending one or more requests to discover adaptation capabilities supported by the second adaptation services 302f. At 704, in accordance with the illustrated embodiment, the first IoT adaptation service 302e publishes its native adaptation capabilities that it supports and the adaptation capabilities of the other adaptation services 302f with which the first adaptation service 302e collaborations, which can be referred to as collaboration partners. At 706, the application 310 may query one or more adaptation services in the network to determine if the one or more adaptation services include an adaptation capability for content merging. For example, in accordance with the illustrated embodiment, at 708, the application 310 queries the first adaptation service 302e with a request message to determine whether the adaptation service 302e supports the capability to merge two instances of content in the manner that the application 310 requires. Because the adaptation services supports collaboration, for example, the IoT application 310 may only need to send a single query to one of the IoT adaptation services, for example the first adaptation service 302e, in the network. At 710, in accordance with the illustrated embodiment, the adaptation service 302d responds that no adaptation capabilities meeting the requested description exist in the network. At 712, the IoT application 310 creates a request for a new adaptation capability that supports merging two content instances based on the requirements of the application 310. At 714, the request is sent to the first IoT adaptation service 302e. At 716, the IoT adaptation service 302e responds that a new adaptation capability has been successfully created. In some cases, the new adaptation capability may be created using an adaptation capability binary with a description of the capability. At 718, the IoT application 310 builds a request to use the new capability. The request may include, for example, the content instances to merge (or links to them) along with the targeted adaptation capability that the adaptation service may use to perform the adaptation (e.g., the new content merge capability). At 720, the IoT application 310 sends the adaptation request for merging content images to the adaptation service 302e. The adaptation service 302e sends a successful response to the network application 310 when the requested adaptation is performed. The successful responses may include the merged content instances. The successful response may include a link to the merged content images. Thus, in response a request for a specific adaptation service that supports a specific adaptation capability, the specific adaptation capability may be created by merging one of the adaptation capabilities native to a first network server with a discovered adaptation capability.

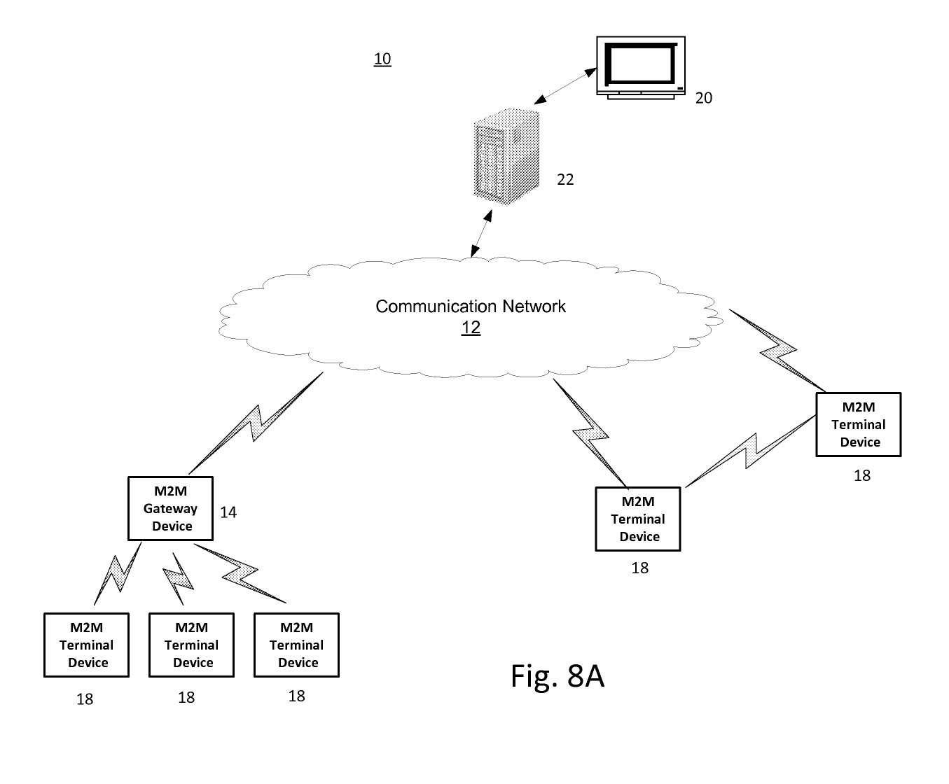

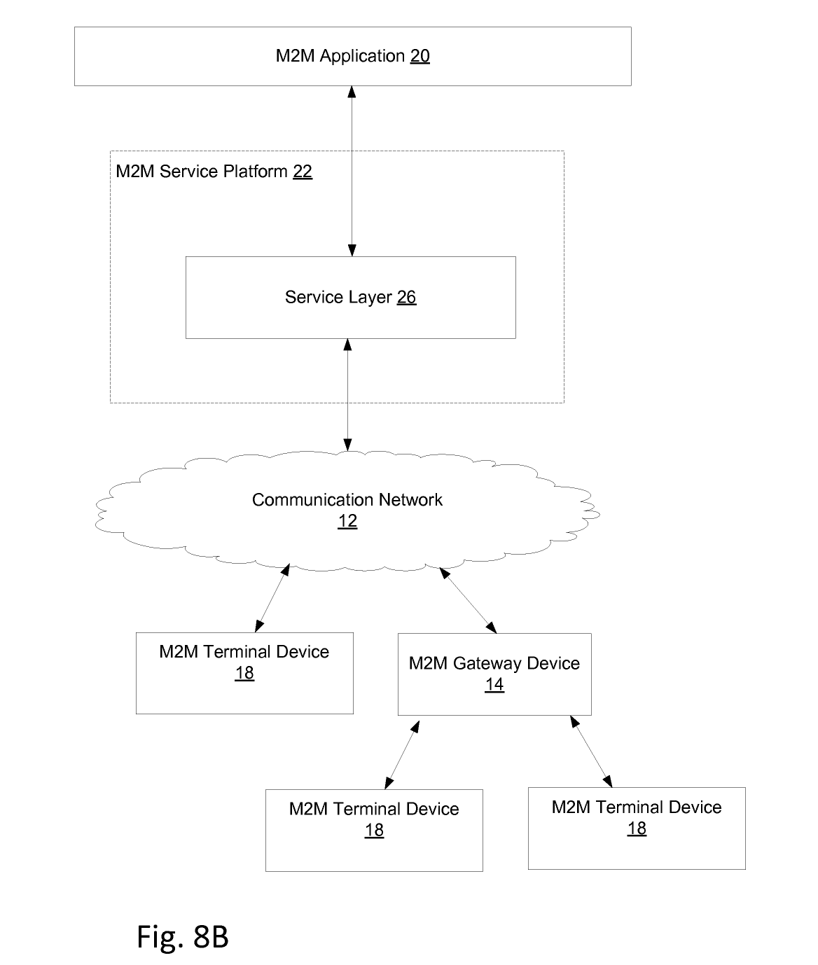

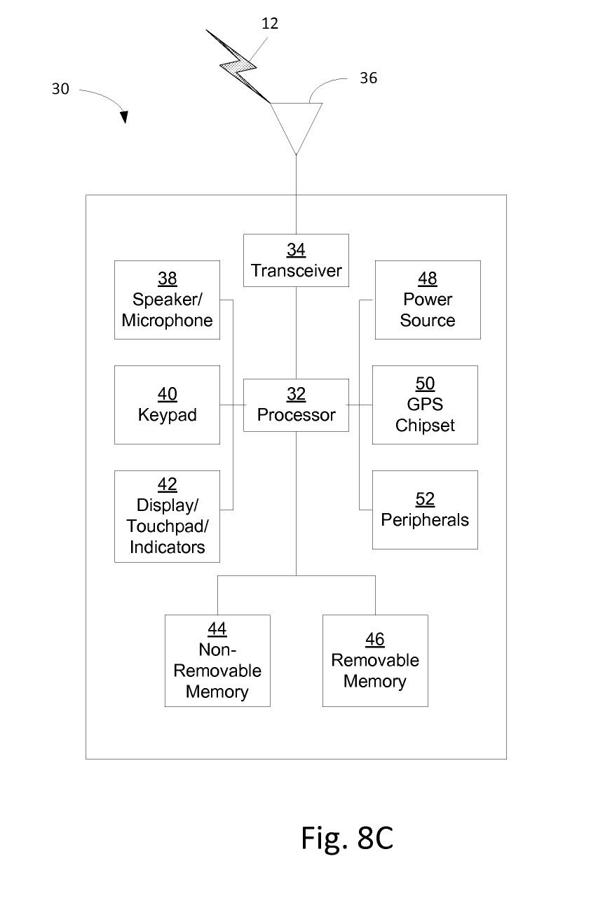

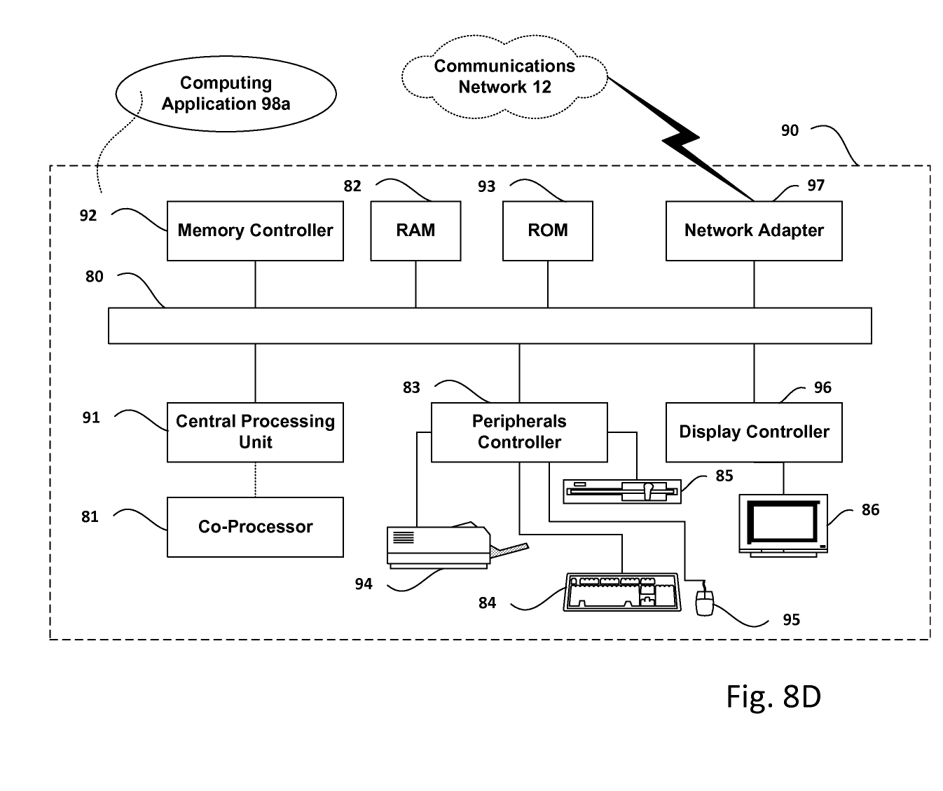

FIG. 8A is a diagram of an example machine-to machine (M2M) or Internet of Things (IoT) communication system 10 in which one or more disclosed embodiments may be implemented. Generally, M2M technologies provide building blocks for the IoT, and any M2M device, gateway or service platform may be a component of the IoT as well as an IoT service layer, etc.

As shown in FIG. 8A, the M2M/IoT communication system 10 includes a communication network 12. The communication network 12 may be a fixed network or a wireless network (e.g., WLAN, cellular, or the like) or a network of heterogeneous networks. For example, the communication network 12 may be comprised of multiple access networks that provides content such as voice, data, video, messaging, broadcast, or the like to multiple users. For example, the communication network 12 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like. Further, the communication network 12 may comprise other networks such as a core network, the Internet, a sensor network, an industrial control network, a personal area network, a fused personal network, a satellite network, a home network, or an enterprise network for example. The processor 32 may be configured to control lighting patterns, images, or colors on the display or indicators 42 in response to whether an IoT adaptation service in accordance with some embodiments described herein is successful or unsuccessful.

As shown in FIG. 8A, the M2M/IoT communication system 10 may include an M2M gateway device 14, and M2M terminal devices 18. It will be appreciated that any number of M2M gateway devices 14 and M2M terminal devices 18 may be included in the M2M/IoT communication system 10 as desired. It will further be appreciated that the above-described applications and services, such as the services 306, the applications 310, or the IoT adaptation services 302 for example, may be implemented by hardware and/or software in ones of the M2M terminal devices 18 or the M2M gateway devices 14. Each of the M2M gateway devices 14 and M2M terminal devices 18 are configured to transmit and receive signals via the communication network 12 or direct radio link. The M2M gateway device 14 allows wireless M2M devices (e.g. cellular and non-cellular) as well as fixed network M2M devices (e.g. PLC) to communicate either through operator networks, such as the communication network 12 or direct radio link. For example, the M2M devices 18 may collect data and send the data, via the communication network 12 or direct radio link, to an M2M application 20 or M2M devices 18. The M2M devices 18 may also receive data from the M2M application 20 or an M2M device 18. Further, data and signals may be sent to and received from the M2M application 20 via an M2M service platform 22, as described below. M2M devices 18 and gateways 14 may communicate via various networks including, cellular, WLAN, WPAN (e.g., Zigbee, 6LoWPAN, Bluetooth), direct radio link, and wireline for example.

The illustrated M2M service platform 22 provides services for the M2M application 20, M2M gateway devices 14, M2M terminal devices 18 and the communication network 12. For example, the M2M service platform 22 may provide the IoT adaptation service 302 in accordance with some embodiments. It will be understood that the M2M service platform 22 may communicate with any number of M2M applications, M2M gateway devices 14, M2M terminal devices 18 and communication networks 12 as desired. The above described adaptation services may reside on the M2M service platform 22 in accordance with an example embodiment. The M2M service platform 22 may be implemented by one or more servers, computers, or the like. The M2M service platform 22 provides services such as management and monitoring of M2M terminal devices 18 and M2M gateway devices 14. The M2M service platform 22 may also collect data and convert the data such that it is compatible with different types of M2M applications 20. The functions of the M2M service platform 22 may be implemented in a variety of ways, for example as a web server, in the cellular core network, in the cloud, etc.

Referring also to FIG. 8B, the M2M service platform typically implements a service layer 26 that provides a core set of service delivery capabilities that diverse applications and verticals can leverage. One or more of the adaptation capabilities 406 may be provided by the service layer 26. These service capabilities enable M2M applications 20 to interact with devices and perform functions such as data collection, data analysis, device management, security, billing, service/device discovery etc. Essentially, these service capabilities free the applications of the burden of implementing these functionalities, thus simplifying application development and reducing cost and time to market. The service layer 26 also enables M2M applications 20 to communicate through various networks 12 in connection with the services that the service layer 26 provides.

The M2M applications 20 may include applications in various industries such as, without limitation, transportation, health and wellness, connected home, energy management, asset tracking, and security and surveillance. As mentioned above, the M2M service layer, running across the devices, gateways, and other servers of the system, supports functions such as, for example, data collection, device management, security, billing, location tracking/geofencing, device/service discovery, and legacy systems integration, and provides these functions as services to the M2M applications 20.

FIG. 8C is a system diagram of an example M2M device 30, such as an M2M terminal device 18 or an M2M gateway device 14 for example. As shown in FIG. 8C, the M2M device 30 may include a processor 32, a transceiver 34, a transmit/receive element 36, a speaker/microphone 38, a keypad 40, a display/touchpad 42, non-removable memory 44, removable memory 46, a power source 48, a global positioning system (GPS) chipset 50, and other peripherals 52. It will be appreciated that the M2M device 40 may include any sub-combination of the foregoing elements while remaining consistent with an embodiment.

The processor 32 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 32 may perform signal coding, data processing, power control, input/output processing, and/or any other functionality that enables the M2M device 30 to operate in a wireless environment. The processor 32 may be coupled to the transceiver 34, which may be coupled to the transmit/receive element 36. While FIG. 8C depicts the processor 32 and the transceiver 34 as separate components, it will be appreciated that the processor 32 and the transceiver 34 may be integrated together in an electronic package or chip. The processor 32 may perform application-layer programs (e.g., browsers) and/or radio access-layer (RAN) programs and/or communications. The processor 32 may perform security operations such as authentication, security key agreement, and/or cryptographic operations, such as at the access-layer and/or application layer for example.

The transmit/receive element 36 may be configured to transmit signals to, or receive signals from, an M2M service platform 22. For example, in an embodiment, the transmit/receive element 36 may be an antenna configured to transmit and/or receive RF signals. The transmit/receive element 36 may support various networks and air interfaces, such as WLAN, WPAN, cellular, and the like. In an embodiment, the transmit/receive element 36 may be an emitter/detector configured to transmit and/or receive IR, UV, or visible light signals, for example. In yet another embodiment, the transmit/receive element 36 may be configured to transmit and receive both RF and light signals. It will be appreciated that the transmit/receive element 36 may be configured to transmit and/or receive any combination of wireless or wired signals.

In addition, although the transmit/receive element 36 is depicted in FIG. 8C as a single element, the M2M device 30 may include any number of transmit/receive elements 36. More specifically, the M2M device 30 may employ MIMO technology. Thus, in an embodiment, the M2M device 30 may include two or more transmit/receive elements 36 (e.g., multiple antennas) for transmitting and receiving wireless signals.

The transceiver 34 may be configured to modulate the signals that are to be transmitted by the transmit/receive element 36 and to demodulate the signals that are received by the transmit/receive element 36. As noted above, the M2M device 30 may have multi-mode capabilities. Thus, the transceiver 34 may include multiple transceivers for enabling the M2M device 30 to communicate via multiple RATs, such as UTRA and IEEE 802.11, for example.

The processor 32 may access information from, and store data in, any type of suitable memory, such as the non-removable memory 44 and/or the removable memory 46. The non-removable memory 44 may include random-access memory (RAM), read-only memory (ROM), a hard disk, or any other type of memory storage device. The removable memory 46 may include a subscriber identity module (SIM) card, a memory stick, a secure digital (SD) memory card, and the like. In other embodiments, the processor 32 may access information from, and store data in, memory that is not physically located on the M2M device 30, such as on a server or a home computer.

The processor 32 may receive power from the power source 48, and may be configured to distribute and/or control the power to the other components in the M2M device 30. The power source 48 may be any suitable device for powering the M2M device 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 32 may also be coupled to the GPS chipset 50, which is configured to provide location information (e.g., longitude and latitude) regarding the current location of the M2M device 30. It will be appreciated that the M2M device 30 may acquire location information by way of any suitable location-determination method while remaining consistent with an embodiment.

The processor 32 may further be coupled to other peripherals 52, which may include one or more software and/or hardware modules that provide additional features, functionality and/or wired or wireless connectivity. For example, the peripherals 52 may include an accelerometer, an e-compass, a satellite transceiver, a sensor, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 8D is a block diagram of an exemplary computing system 90 on which, for example, the M2M service platform 22 of FIGS. 8A and 8B may be implemented. Computing system 90 may comprise a computer or server and may be controlled primarily by computer readable instructions, which may be in the form of software, wherever, or by whatever means such software is stored or accessed. Such computer readable instructions may be executed within central processing unit (CPU) 91 to cause computing system 90 to do work. In many known workstations, servers, and personal computers, central processing unit 91 is implemented by a single-chip CPU called a microprocessor. In other machines, the central processing unit 91 may comprise multiple processors. Coprocessor 81 is an optional processor, distinct from main CPU 91, that performs additional functions or assists CPU 91.

In operation, CPU 91 fetches, decodes, and executes instructions, and transfers information to and from other resources via the computer's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memory devices coupled to system bus 80 include random access memory (RAM) 82 and read only memory (ROM) 93. Such memories include circuitry that allows information to be stored and retrieved. ROMs 93 generally contain stored data that cannot easily be modified. Data stored in RAM 82 can be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode can access only memory mapped by its own process virtual address space; it cannot access memory within another process's virtual address space unless memory sharing between the processes has been set up.

In addition, computing system 90 may contain peripherals controller 83 responsible for communicating instructions from CPU 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may contain network adaptor 97 that may be used to connect computing system 90 to an external communications network, such as network 12 of FIGS. 8A and 8B.

It is understood that any or all of the systems, methods, and processes described herein may be embodied in the form of computer executable instructions (i.e., program code) stored on a computer-readable storage medium that, when executed by a machine, such as a computer, server, M2M terminal device, M2M gateway device, or the like, perform and/or implement the systems, methods and processes described herein. Specifically, any of the steps, operations or functions described above may be implemented in the form of such computer executable instructions. Computer readable storage media include both volatile and nonvolatile, removable and non-removable media implemented in any method or technology for storage of information, but such computer readable storage media do not includes signals. Computer readable storage media include, but are not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other physical medium which can be used to store the desired information and which can be accessed by a computer.

In describing preferred embodiments of the subject matter of the present disclosure, as illustrated in the figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose.

This written description uses examples to disclose the invention, including the best mode, and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed:

1. A method comprising:
determining, at a network server, that a service provided by a network entity should be adapted for a first client and a second client that is different than the first client;
generating first instructions for the network entity to adapt the service that the network entity provides such that the service is compatible with the first client;
generating second instructions for the network entity to adapt the service that the network entity provides such that the service is compatible with the second client; and
sending the first and second instructions to the network entity, the first instructions different than the second instructions.

2. The method as recited in claim 1, the method further comprising:
monitoring, by the network server, the service provided by the network entity, wherein determining that the service provided by the network entity should be adapted for the first client and second client is based on monitoring the service.

3. The method as recited in claim 1, wherein the first client and the second client subscribe to an adaptation service hosted at the network server such that the first client has a first subscription with the adaptation service and the second client has a second subscription with the adaptation service, and wherein the first and second instructions are generated based on the first and second subscriptions, respectively.

4. The method as recited in claim 1, the method further comprising:
receiving, at the network server, a plurality of adaptation requests, at least one of the plurality of adaptation requests associated with the first client and at least one of the plurality of adaptation requests associated with the second client that is different than the first client, wherein determining that the service provided by the network entity should be adapted for the first client and the second client is based on receiving the plurality of adaptation requests.

5. The method of claim 4, wherein the network entity has an interface that is non-compatible with the first client, the at least one of the plurality of adaptation requests associated with the first client comprising a request to adapt the service such that the first client can access the network entity.

6. The method of claim 5, wherein the at least one of the plurality of adaptation requests associated with the first client includes interface requirements of the first client.

7. The method of claim 6, wherein the first instructions comprise an adapted interface that meets the interface requirements of the first client.

8. The method of claim 1, wherein the first instructions comprise a type of adaptation for the network entity to perform and an interface description of the first client.

9. The method of claim 1, wherein the service that the network entity provides is an IoT content storage network service.

10. The method of claim 1, the method further comprising:
retrieving, by the network server, a plurality of adaptation capabilities to perform a plurality of adaptation services.

11. The method of claim 10, wherein at least one of the plurality of adaptation capabilities are retrieved from an adaptation capability library stored at the network server.

12. The method of claim 10, wherein at least one of the plurality of adaptation capabilities are retrieved from a library stored at another network server.

13. The method of claim 1, wherein the service that the network entity provides is an IoT virtualization network service, the method further comprising:
receiving a subscription request from the IoT virtualization network service, the subscription request indicating a network policy of the IoT virtualization network service.

14. The method of claim 13, wherein the first client resides on a first IoT device, the method further comprising:
receiving, at the network server, a plurality of adaptation requests, at least one of the plurality of adaptation requests associated with the first client and at least one of the plurality of adaptation requests associated with the second client that is different than the first client, wherein the at least one of the plurality of adaptation requests associated with the first client comprises a first event notification indicative of a status of the first IoT device.

15. The method of claim 14, the method further comprising:
based on the first event notification and the network policy, generating the first instructions that include an adapted version of the network policy so that the IoT entity can perform the IoT virtualization network service for the first IoT device.

16. The method of claim 14, wherein the first IoT device is a sensor.

17. The method of claim 16, wherein the first event notification indicates that the sensor is overloaded.

18. The method of claim 1, wherein the network server is a first network server, the method further comprising:
sending a request to discover adaptation capabilities supported by adaptation services that reside on a second network server;
discovering a plurality of adaptation capabilities supported by the adaptation services that reside on the second network server; and
publishing, by the first network server, the discovered adaptation capabilities and adaptation capabilities native to the first network server.

19. The method of claim 18, the method further comprising:
receiving, at the network server, a request from the network entity for a specific adaptation service that supports a specific adaptation capability.

20. The method of claim 19, the method further comprising:
in response to the request for the specific adaptation service that supports the specific adaptation capability, creating the specific adaptation capability by merging one of the adaptation capabilities native to the first network server with one of the discovered adaptation capabilities.

21. A network server that communicates in a network, the network server comprising:
a memory comprising executable instructions; and
a processor that, when executing the executable instructions, effectuates operations comprising:
determining that a service provided by a network entity should be adapted for a first client and a second client that is different than the first client;
generating first instructions for the network entity to adapt the service that the network entity provides such that the service is compatible with the first client;
generating second instructions for the network entity to adapt the service that the network entity provides such that the service is compatible with the second client; and
sending the first and second instructions to the network entity, the first instructions different than the second instructions.

22. The network entity as recited in claim 21, wherein the processor further effectuates operations comprising:
receiving, at the network server, a plurality of adaptation requests, at least one of the plurality of adaptation requests associated with the first client and at least one of the plurality of adaptation requests associated with the second client that is different than the first client, wherein determining that the service should be adapted for the first and second client is based on receiving the plurality of adaptation requests.
